(19) United States
(12) Patent Application Publication
(10) Pub. No.: US 2022/0374707 A1
(43) Pub. Date: Nov. 24, 2022

(54) INFORMATION PROCESSING METHOD, INFORMATION PROCESSING APPARATUS, AND NON-TRANSITORY COMPUTER-READABLE STORAGE MEDIUM

(71) Applicant: Actapio, Inc., East Wenatchee, WA (US)

(72) Inventor: Shinichiro OKAMOTO, Wenatchee, WA (US)

(21) Appl. No.: 17/746,317

(22) Filed: May 17, 2022

Related U.S. Application Data
(60) Provisional application No. 63/191,280, filed on May 20, 2021.

(51) Int. Cl. G06N 3/08; G06N 3/04

(52) U.S. Cl. CPC G06N 3/08; G06N 3/0454

(57) ABSTRACT

An information processing method according to the present application is an information processing method executed by a computer, the information processing method including: acquiring learning data used for training of a model including a first partial model and a second partial model; and generating, by using the learning data, the model in a manner in which the first partial model is trained by first dropout based on a first dropout rate and the second partial model is trained by second dropout based on a second dropout rate different from the first dropout rate.

### TECHNICAL FIELD

The present invention relates to an information processing method, an information processing apparatus, and a non-transitory computer-readable storage medium having stored therein an information processing program.

### BACKGROUND ART

In recent years, a technology, in which various models such as a neural network such as a deep neural network (DNN) are caused to perform various predictions and classifications by training the models with a feature of learning data, has been proposed. In such training of the models, a training method such as dropout is used.

Patent Literature 1: JP 2020-071862 A

### DISCLOSURE OF INVENTION

### Problem to be Solved by the Invention

In addition, the above-described technology has room for improvement in generation of a model. For example, in the above-described example, the dropout is merely performed before a softmax layer, and it is desired to generate a model by a more flexible training method according to the structure of the model.

### Means for Solving Problem

An information processing method according to the present application is an information processing method executed by a computer, the information processing method including: acquiring learning data used for training of a model including a first partial model and a second partial model; and generating, by using the learning data, the model in a manner in which the first partial model is trained by first dropout based on a first dropout rate and the second partial model is trained by second dropout based on a second dropout rate different from the first dropout rate.

### Effect of the Invention

According to one aspect of the embodiment, the model can be appropriately generated by training according to the structure of the model.

### BRIEF DESCRIPTION OF DRAWINGS

FIG. 1 is a diagram illustrating an example of an information processing system according to an embodiment;

FIG. 2 is a diagram illustrating an example of a flow of model generation using an information processing apparatus according to the embodiment;

FIG. 3 is a diagram illustrating a configuration example of the information processing apparatus according to the embodiment;

FIG. 4 is a diagram illustrating an example of information registered in a learning data database according to the embodiment;

FIG. 5 is a fiowchart illustrating an example of a flow of information processing according to the embodiment;

FIG. 6 is a flowchart illustrating the example of the flow of the information processing according to the embodiment;

FIG. 7 is a diagram illustrating an example of a structure of a model according to the embodiment;

FIG. 8 is a diagram illustrating an example of a parameter according to the embodiment;

FIG. 9 is a diagram illustrating a concept of dropout according to the embodiment;

FIG. 10 is a diagram illustrating a concept of batch normalization according to the embodiment;

FIG. 11 is a graph related to a first finding;

FIG. 12 is a graph related to a second finding;

FIG. 13 is a graph related to the second finding;

FIG. 14 is a graph related to a third finding;

FIG. 15 is a diagram illustrating an example of a model related to a fourth finding;

FIG. 16 is a graph relating to the fourth finding;

FIG. 17 is a diagram illustrating a list of experimental results; and

FIG. 18 is a diagram illustrating an example of a hardware configuration.

### BEST MODE(S) OF CARRYING OUT THE INVENTION

Hereinafter, a mode (hereinafter referred to as “an embodiment”) for carrying out an information processing method, an information processing apparatus, and a non-transitory computer-readable storage medium having stored therein an information processing program according to the present application will be described in detail with reference to the drawings. Note that the information processing method, the information processing apparatus, and the information processing program according to the present application are not limited by this embodiment. In addition, respective embodiments can be appropriately combined with each other as long as processing contents do not contradict each other. In addition, in each of the following embodiments, the same portions will be denoted by the same reference signs, and an overlapping description thereof will be omitted.

[Embodiment] In the following embodiment, first, a premise of a system configuration or the like will be described, and then processing of generating a model by performing dropout processing on each partial model in training at the time of generating a model including a plurality of partial models will be described. Note that, in the following description, among the partial models, a partial model that does not include a hidden layer may be referred to as a first-type partial model, and a partial model that includes a hidden layer may be referred to as a second-type partial model. In addition, after the processing of generating the model is described, findings and experimental results obtained by generating the model as described above will be presented and described. Note that, although described in detail later, there is a correlation between a dropout rate, accuracy, and the size of the hidden layer, and the accuracy can be improved by increasing the dropout rate or adjusting the size of the hidden layer based on the dropout rate. It is considered that the model is appropriately generated and the output (an inference result such as classification) of the model becomes more natural by increasing the dropout rate or adjusting the size of the hidden layer based on the dropout rate. As described above, it is considered that the output of the model becomes more natural, which leads to improvement of the accuracy of the model. In the present embodiment, a configuration and the like of an information processing system 1 that generates a model will be first described before the generation of the model, the findings, and the like described above are illustrated.

### [1. Configuration of Information Processing System]

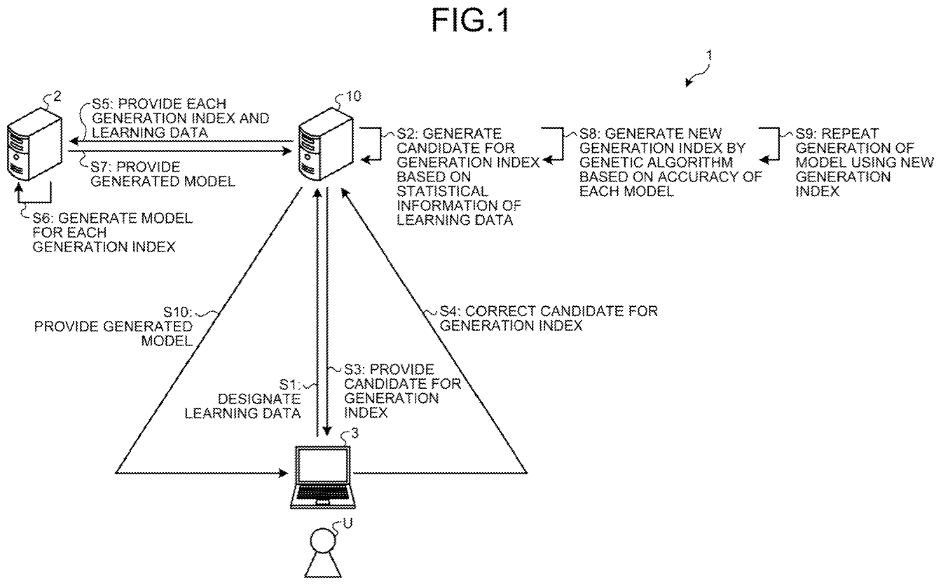

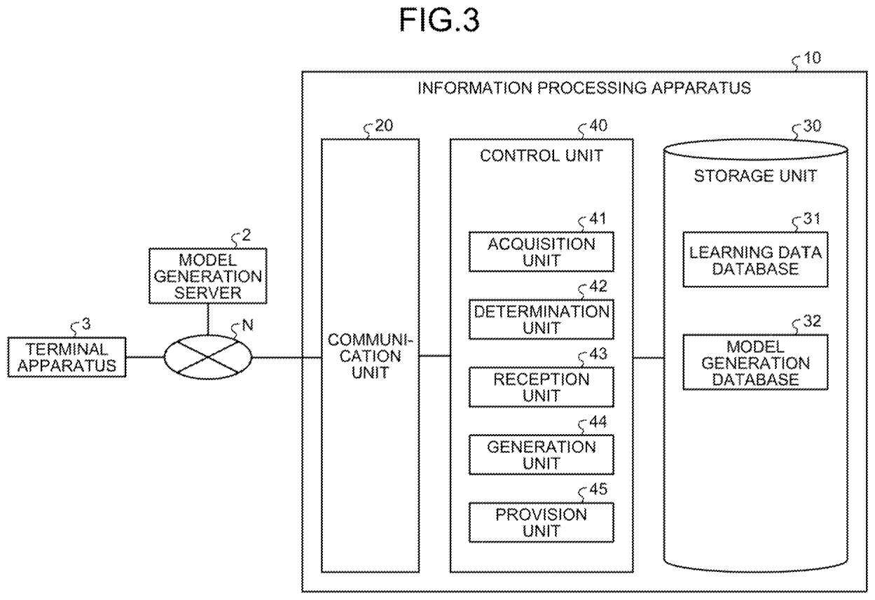

First, a configuration of the information processing system including an information processing apparatus 10, which is an example of an information processing apparatus, will be described with reference to FIG. 1. FIG. 1 is a diagram illustrating an example of the information processing system according to an embodiment. As illustrated in FIG. 1, the information processing system 1 includes the information processing apparatus 10, a model generation server 2, and a terminal apparatus 3. Note that the information processing system 1 may include a plurality of model generation servers 2 and a plurality of terminal apparatuses 3. Furthermore, the information processing apparatus 10 and the model generation server 2 may be implemented by the same server apparatus, cloud system, or the like. Here, the information processing apparatus 10, the model generation server 2, and the terminal apparatus 3 are communicably connected in a wired or wireless manner via a network N (see, for example, FIG. 3).

The information processing apparatus 10 is an information processing apparatus that performs index generation processing of generating a generation index, which is an index in model generation (that is, a recipe of a model) and model generation processing of generating the model according to the generation index and provides the generated generation index and the model, and is implemented by, for example, a server apparatus, a cloud system, or the like.

The model generation server 2 is an information processing apparatus that generates a model that has been trained with a feature of learning data, and is implemented by, for example, a server apparatus, a cloud system, or the like. For example, once the model generation server 2 receives, as the model generation index, a configuration file indicating the type and behavior of the model to be generated and how to perform training with the feature of the learning data, the mode generation server 2 automatically generates the model according to the received configuration file. Note that the model generation server 2 may train the model by using an arbitrary model training technique. Furthermore, for example, the model generation server 2 may be various existing services such as automated machine learning (AutoML).

The terminal apparatus 3 is a terminal apparatus used by a user U, and is implemented by, for example, a personal computer (PC), a server apparatus, or the like. For example, the terminal apparatus 3 performs communication with the information processing apparatus 10 to cause the information processing apparatus 10 to generate the model generation index, and acquires the model generated by the model generation server 2 according to the generated generation index.

### [2. Outline of Processing Performed by Information Processing Apparatus 10]

First, an outline of processing performed by the information processing apparatus 10 will be described. First, the information processing apparatus 10 receives an indication of learning data whose feature is to be learned by a model, from the terminal apparatus 3 (Step S1). For example, the information processing apparatus 10 stores various kinds of learning data used for training in a predetermined storage device, and receives an indication of learning data specified as the learning data by the user U. Note that the information processing apparatus 10 may acquire the learning data used for training from the terminal apparatus 3 or various external servers, for example.

Here, as the learning data, arbitrary data can be adopted. For example, the information processing apparatus 10 may use, as the learning data, various pieces of information regarding the user, such as a history of the position of each user, a history of web contents browsed by each user, a purchase history of each user, and a search query history. Furthermore, the information processing apparatus 10 may use, as the learning data, demographic attributes, psychographic attributes, and the like of the user. Furthermore, the information processing apparatus 10 may use, as the learning data, the type or content of various kinds of web contents to be distributed, metadata of a creator or the like, or the like.

In such a case, the information processing apparatus 10 generates a candidate for the generation index based on statistical information of the learning data used for training (Step S2). For example, the information processing apparatus 10 generates a candidate for a generation index indicating which model and which training technique should be used to perform training based on a feature of a value included in the learning data or the like. In other words, the information processing apparatus 10 generates, as the generation index, a model capable of accurately learning the feature of the learning data or a training technique for causing a model to accurately learn the feature. That is, the information processing apparatus 10 optimizes the training technique. Note that what kind of content of the generation index is generated in a case where what kind of learning data is selected will be described later.

Subsequently, the information processing apparatus 10 provides the candidate for the generation index to the terminal apparatus 3 (Step S3). In such a case, the user U corrects the candidate for the generation index according to preference, the empirical rule, or the like (Step S4). Then, the information processing apparatus 10 provides the candidate for each generation index and the learning data to the model generation server 2 (Step S5).

On the other hand, the model generation server 2 generates a model based on each generation index (Step S6). For example, the model generation server 2 trains the model having a structure indicated by the generation index with the feature of the learning data by the training technique indicated by the generation index. Then, the model generation server 2 provides the generated model to the information processing apparatus 10 (Step S7).

Here, it is considered that the respective models generated by the model generation server 2 are different in accuracy due to a difference in generation index. Therefore, the information processing apparatus 10 generates a new generation index by a genetic algorithm based on the accuracy of each model (Step S8), and repeatedly performs model generation by using the newly generated generation index (Step S9).

For example, the information processing apparatus 10 divides the learning data into data for evaluation and data for training, and acquires a plurality of models generated according to different generation indexes, the models having learned features of the data for training. For example, the information processing apparatus 10 generates 10 generation indexes, and generates 10 models by using the generated 10 generation indexes aid the data for training. In such a case, the information processing apparatus 10 measures the accuracy of each of the 10 models by using the data for evaluation.

Subsequently, the information processing apparatus 10 selects a predetermined number of models (for example, five) in descending order of accuracy from among the 10 models. Then, the information processing apparatus 10 generates a new generation index from the generation indexes adopted when the selected five models are generated. For example, the information processing apparatus 10 considers each generation index as an individual of the genetic algorithm, and considers the type of the model, the structure of the model, and various training techniques (that is, various indexes indicated by the generation index) indicated by each generation index as genes in the genetic algorithm. Then, the information processing apparatus 10 newly generates 10 next-generation generation indexes by selecting individuals to perform crossover of genes and performing crossover of genes. Note that the information processing apparatus 10 may consider mutation when performing crossover of genes. Furthermore, the information processing apparatus 10 may perform two-point crossover, multi-point crossover, uniform crossover, and random selection of genes to be subjected to crossover. Furthermore, for example, the information processing apparatus 10 may adjust a crossover rate at the time of performing the crossover so that genes of an individual having higher model accuracy are taken over to the next-generation individual.

Furthermore, the information processing apparatus 10 generates new 10 models again by using the next-generation indexes. Then, the information processing apparatus 10 generates new generation indexes by the genetic algorithm described above based on the accuracy of the new 10 models. By repeatedly performing such processing, the information processing apparatus 10 can bring the generation index closer to the generation index according to the feature of the learning data, that is, the optimized generation index.

Furthermore, in a case where a predetermined condition is satisfied, for example, in a case where a new generation index is generated a predetermined number of times or a case where the maximum value, the average value, or the minimum value of the accuracy of the model exceeds a predetermined threshold, the information processing apparatus 10 selects a model having the highest accuracy as a provision target. Then, the information processing apparatus 10 provides the corresponding generation index to the terminal apparatus 3 together with the selected model (Step S10). As a result of such processing, the information processing apparatus 10 can generate an appropriate model generation index and provide a model according to the generated generation index only with the selection of the learning data by the user.

Note that, in the above-described example, the information processing apparatus 10 realizes stepwise optimization of the generation index using the genetic algorithm, but the embodiment is not limited thereto. As will be apparent in the following description, the accuracy of the model is greatly changed depending on an index at the time of generating the model (that is, when the feature of the learning data is learned), such as how and what kind of learning data is input to the model or what kind of hyperparameter is used to train the model, in addition to the features of the model itself such as the type and structure of the model.

Therefore, the information processing apparatus 10 does not have to perform the optimization using the genetic algorithm as long as the generation index estimated to be optimal is generated according to the learning data. For example, the information processing apparatus 10 may present the generation index generated according to whether or not the learning data satisfies various conditions generated according to the empirical rule to the user, and generate the model according to the presented generation index. Furthermore, in a case where correction of the presented generation index is accepted, the information processing apparatus 10 may generate the model according to the corrected generation index, present the accuracy or the like of the generated model to the user, and accept the correction of the generation index again. That is, the information processing apparatus 10 may allow the user U to undergo trial and error for an optimum generation index.

### [3. Generation of Generation Index]

Hereinafter, an example of what kind of generation index is generated for what kind of learning data will be described. Note that the following example is merely an example, and any processing can be adopted as long as the generation index is generated according to the feature of the learning data.

[3-1. Generation Index]

First, an example of information indicated by the generation index will be described. For example, in a case where the model is trained with the feature of the learning data, it is considered that factors including a manner in which the learning data is input to the model, the structure of the model, and a training mode of the model (that is, the feature indicated by the hyperparameter) contribute to the accuracy of the finally obtained model. Therefore, the information processing apparatus 10 improves the accuracy of the model by generating the generation index in which each factor is optimized according to the feature of the learning data.

For example, it is considered that the learning data includes data to which various labels are given, that is, data having various features. However, in a case where data having an unuseful feature is used as the learning data when classifying data, the accuracy of a finally obtained model may deteriorate. Therefore, the information processing apparatus 10 determines the feature of the learning data to be input as the manner in which the learning data is input to the model. For example, the information processing apparatus 10 determines data having which label (that is, data having which feature) is to be input among the learning data. In other words, the information processing apparatus 10 optimizes a combination of features to be input.

In addition, it is considered that the learning data includes various types of columns such as data including only numerical values and data including character strings. When such learning data is input to the model, it is considered that the accuracy of the model is different between a case where the learning data is input as it is and a case where the learning data is converted into data of another format. For example, it is considered that, when a plurality of types of learning data (pieces of learning data having different features), that is, learning data including a character string and learning data including a numerical value are input, the accuracy of the model is different between a case where the character string and the numerical value are input as they are, a case where the character string is converted into the numerical value and only the numerical values are input, and a case where the numerical value is regarded as the character string at the time of being input. Therefore, the information processing apparatus 10 determines the format of the learning data to be input to the model. For example, the information processing apparatus 10 determines whether the format of the learning data to be input to the model is a numerical value or a character string. In other words, the information processing apparatus 10 optimizes the column type of the input feature.

In addition, in a case where there are pieces of learning data having different features, it is considered that the accuracy of the model is changed depending on which combination of features is simultaneously input. That is, in a case where there are pieces of learning data having different features, it is considered that the accuracy of the model is changed depending on features of which combination of the features (that is, a relationship of a combination of a plurality of features) are learned. For example, in a case where there are learning data having a first feature (for example, gender), learning data having a second feature (for example, address), and learning data having a third feature (for example, purchase history), it is considered that the accuracy of the model is different between a case where the learning data having the first feature and the learning data having the second feature are simultaneously input and a case where the learning data having the first feature and the learning data having the third feature are simultaneously input. Therefore, the information processing apparatus 10 optimizes a combination (cross feature) of features whose relationship is to be learned by the model.

Here, various models project input data onto a space having predetermined dimensions and divided by a predetermined hyperplane, and classify the input data according to a space to which a position to which the data is projected belongs among the divided spaces. Therefore, in a case where the number of dimensions of the space onto which the input data is projected is less than the optimum number of dimensions, input data classification performance deteriorates, and as a result, the accuracy of the model deteriorates. In addition, in a case where the number of dimensions of the space onto which the input data is projected is more than the optimum number of dimensions, the inner product value with respect to the hyperplane is changed, and as a result, there is a possibility that data different from the data used at the time of training is not appropriately classified. Therefore, the information processing apparatus 10 optimizes the number of dimensions of the input data that is to be input to the model. For example, the information processing apparatus 10 optimizes the number of dimensions of the input data by controlling the number of nodes of an input layer included in the model. In other words, the information processing apparatus 10 optimizes the number of dimensions of the space in which the input data is to be embedded.

In addition, examples of the model include a neural network having a plurality of intermediate layers (hidden layers) in addition to an SVM. As such a neural network, various neural networks are known, such as a feedforward DNN in which information is transmitted from the input layer to an output layer in one direction, a convolutional neural network (CNN) in which convolution of information is performed in the intermediate layer, a recurrent neural network (RNN) having a directed cycle, and a Boltzmann machine. Such various types of neural networks also include a long short-term memory (LSTM) and other types of neural networks.

As described above, it is considered that the accuracy of the model is changed in a case where the type of the model that learns various features of the learning data is different. Therefore, the information processing apparatus 10 selects the type of the model that is expected to accurately learn the feature of the learning data. For example, the information processing apparatus 10 selects the type of the model depending on what kind of label is assigned as the label of the learning data. More specifically, in a case where there is data to which a term related to “history” is assigned as a label, the information processing apparatus 10 selects an RNN that is considered to be able to more accurately learn the feature of the history, and in a case where there is data to which a term related to “image” is assigned as a label, the information processing apparatus 10 selects a CNN that is considered to be able to more accurately learn the feature of the image. In addition to these, the information processing apparatus 10 may determine whether or not the label is a term designated in advance or a term similar to the term, and select a model of a type associated in advance with a term that is determined to be the same or similar to the term.

In addition, it is considered that the accuracy in training of the model is changed in a case where the number of intermediate layers of the model or the number of nodes included in one intermediate layer is changed. For example, in a case where the number of intermediate layers of the model is large (in a case where the model is deeper), it is considered that classification according to a more abstract feature can be implemented, but there is a possibility that training cannot be appropriately performed because a local error is difficult to be back-propagated to the input layer. In addition, in a case where the number of nodes included in the intermediate layer is small, higher-level abstraction can be made, but in a case where the number of nodes is excessively small, there is a high possibility that information necessary for classification is lost. Therefore, the information processing apparatus 10 optimizes the number of intermediate layers and the number of nodes included in the intermediate layer. That is, the information processing apparatus 10 optimizes the architecture of the model.

In addition, it is considered that the accuracy of the node is changed depending on whether or not attention is used, whether or not auto-regression is used for the node included in the model, and which node is connected. Therefore, the information processing apparatus 10 performs optimization of the network as to, for example, whether or not the auto-regression is used for the network and which node is connected.

In addition, in a case of training the model, a model optimization technique (an algorithm used at the time of learning), a dropout rate, a node activation function, the number of units, and the like are set as hyperparameters. In a case where such hyperparameters are changed, it is also considered that the accuracy of the model is changed. Therefore, the information processing apparatus 10 optimizes a training mode at the time of training the model, that is, the information processing apparatus 10 optimizes the hyperparameters.

The accuracy of the model is also changed when the size (the number of input layers, the number of intermediate layers, the number of output layers, and the number of nodes) of the model is changed. Therefore, the information processing apparatus 10 also optimizes the size of the model.

In this manner, the information processing apparatus 10 optimizes the indexes used when generating various models described above. For example, the information processing apparatus 10 holds a condition corresponding to each index in advance. Note that such a condition is set based on, for example, the empirical rule such as the accuracy of various models generated from the past training models. Then, the information processing apparatus 10 determines whether or not the learning data satisfies each condition, and adopts an index associated in advance with the condition that the learning data satisfies or does not satisfy as the generation index (or a candidate therefor). As a result, the information processing apparatus 10 can generate the generation index that allows accurate learning of the feature of the learning data.

Note that in a case where the processing of automatically generating the generation index from the learning data and creating the model according to the generation index is automatically performed as described above, the user need not refer to the content of the learning data and determine data having what kind of distribution exists. As a result, for example, the information processing apparatus 10 can reduce time and effort for data scientists and the like to recognize the learning data at the time of creating the model, and can prevent damage to privacy resulting from the recognition of the learning data.

[3-2. Generation Index According to Data Type]

Hereinafter, an example of a condition for generating the generation index will be described. First, an example of a condition according to the type of the data adopted as the learning data will be described.

For example, the learning data used for training includes an integer, a floating point number, a character string, or the like as data. Therefore, in a case where an appropriate model is selected according to the format of the input data, it is estimated that the accuracy in training the model is improved. Therefore, the information processing apparatus 10 generates the generation index based on whether the learning data is an integer, a floating point number, or a character string.

For example, in a case where the learning data is an integer, the information processing apparatus 10 generates the generation index based on the continuity of the learning data. For example, in a case where the density of the learning data exceeds a predetermined first threshold, the information processing apparatus 10 considers that the learning data is data having continuity, and generates the generation index based on whether or not the maximum value of the learning data exceeds a predetermined second threshold. Furthermore, in a case where the density of the learning data is lower than the predetermined first threshold, the information processing apparatus 10 considers that the learning data is sparse learning data, and generates the generation index based on whether or not the number of unique values included in the learning data exceeds a predetermined third threshold.

A more specific example will be described. Note that, in the following example, an example of processing of selecting, as the generation index, a feature function from configuration files to be transmitted to the model generation server 2 that automatically generates the model by using AutoML will be described. For example, in a case where the learning data is an integer, the information processing apparatus 10 determines whether or not the density exceeds the predetermined first threshold. For example, the information processing apparatus 10 calculates, as the density, a value obtained by dividing the number of unique values among the values included in the learning data by a value obtained by adding 1 to the maximum value of the learning data.

Subsequently, in a case where the density exceeds the predetermined first threshold, the information processing apparatus 10 determines that the learning data is learning data having continuity, and determines whether or not the value obtained by adding 1 to the maximum value of the learning data exceeds the second threshold. Then, in a case where the value obtained by adding 1 to the maximum value of the learning data exceeds the second threshold, the information processing apparatus 10 selects “Categorical_colum_with_identity & embedding_column” as the feature function. On the other hand, in a case where the value obtained by adding 1 to the maximum value of the learning data is less than the second threshold, the information processing apparatus 10 selects “Categorical_column_with_identity” as the feature function.

On the other hand, in a case where the density is lower than the predetermined first threshold, the information processing apparatus 10 determines that the learning data is sparse, and determines whether or not the number of unique values included in the learning data exceeds the predetermined third threshold. Then, in a case where the number of unique values included in the learning data exceeds the predetermined third threshold, the information processing apparatus 10 selects “Categorical_column_with_hash_bucket & embedding_column” as the feature function, and in a case where the number of unique values included in the learning data is less than the predetermined third threshold, the information processing apparatus 10 selects “Categorical_column_with_hash_bucket” as the feature function.

Furthermore, in a case where the learning data is a character string, the information processing apparatus 10 generates the generation index based on the number of types of character strings included in the learning data. For example, the information processing apparatus 10 counts the number of unique character strings (the number of pieces of unique data) included in the learning data, and in a case where the counted number is less than a predetermined fourth threshold, the information processing apparatus 10 selects “categorical_column_with_vocabulary_list” or/and “categorical_column_with_vocabulary_file” as the feature function. In a case where the counted number is less than a fifth threshold larger than the predetermined fourth threshold, the information processing apparatus 10 selects “categorical_column_with_vocabulary_file & embedding_column” as the feature function. Furthermore, in a case where the counted number exceeds the fifth threshold larger than the predetermined fourth threshold, the information processing apparatus 10 selects “categorical_column_with_hash_bucket & embedding_column” as the feature function.

Furthermore, in a case where the learning data is a floating point number, the information processing apparatus 10 generates, as the model generation index, a conversion index for converting the learning data into input data to be input to the model. For example, the information processing apparatus 10 selects “bucketized_column” or “numeric_column” as the feature function. That is, the information processing apparatus 10 bucketizes (groups) the learning data and selects whether or not to input a bucket number or directly input the numerical value as it is. Note that, for example, the information processing apparatus 10 may perform packetization of the learning data so that the range of the numerical value associated with each bucket is substantially the same, or for example, may associate the range of the numerical value with each bucket so that the number of pieces of learning data classified into each bucket is substantially the same. Furthermore, the information processing apparatus 10 may select the number of buckets or a range of the numerical value associated with the bucket as the generation index.

Furthermore, the information processing apparatus 10 acquires learning data having a plurality of features, and generates, as the model generation index, a generation index indicating a feature to be learned by the model among the features of the learning data. For example, the information processing apparatus 10 determines a label that is assigned to the learning data to be input to the model, and generates a generation index indicating the determined label. Furthermore, the information processing apparatus 10 generates, as the model generation index, a generation index indicating a plurality of types having a correlation to be learned by the model among the types of the learning data. For example, the information processing apparatus 10 determines a combination of labels to be simultaneously input to the model, and generates a generation index indicating the determined combination.

Furthermore, the information processing apparatus 10 generates a generation index indicating the number of dimensions of the learning data to be input to the model as the model generation index. For example, the information processing apparatus 10 may determine the number of nodes in the input layer of the model according to the number of pieces of unique data included in the learning data, the number of labels to be input to the model, a combination of the numbers of labels to be input to the model, the number of buckets, and the like.

Furthermore, the information processing apparatus 10 generates a generation index indicating the type of the model that is to be trained with the feature of the learning data, as the model generation index. For example, the information processing apparatus 10 determines the type of the model to be generated according to the density or sparsity of the learning data used for training in the past, the content of the label, the number of labels, the number of combinations of the labels, and the like, and generates a generation index indicating the determined type. For example, the information processing apparatus 10 generates a generation index indicating “BaselineClassifier”, “LinearClassifier”, “DNNClassifier”, “DNNLinearCombinedClassifier”, “BoostedTreesClassifier”, “AdaNetClassifier”, “RNNClassifier”, “DNNResNetClassifier”, “AutolntClassifier”, or the like as an AutoML model class.

Note that the information processing apparatus 10 may generate a generation index indicating various independent variables of the models of these respective classes. For example, the information processing apparatus 10 may generate a generation index indicating the number of intermediate layers included in the model or the number of nodes included in each layer as the model generation index. Furthermore, the information processing apparatus 10 may generate a generation index indicating a mode of connection between the nodes included in the model or a generation index indicating the size of the model as the model generation index of the model. These independent variables are appropriately selected according to whether or nor various statistical features of the learning data satisfy a predetermined condition.

Furthermore, the information processing apparatus 10 may generate, as the model generation index, a generation index indicating a training mode used when the model is trained with the feature of the learning data, that is, the hyperparameter. For example, the information processing apparatus 10 may generate a generation index indicating “stop_if_no_decrease_hook”, “stop_if_no_increase_hook”, “stop_if_higher_hook”, or “stop_if_lower_hook” in the setting of the training mode in AutoML.

That is, based on the label of the learning data used for training and the feature of the data itself, the information processing apparatus 10 generates a generation index indicating the feature of the learning data learned by the model, the structure of the model to be generated, and the training mode used when the model is trained with the feature of the learning data. More specifically, the information processing apparatus 10 generates a configuration file for controlling the generation of the model in AutoML.

[3-3. Order in which Generation Indexes are Determined]

Here, the information processing apparatus 10 may perform the optimizations of the various indexes described above simultaneously in parallel, or may perform the optimizations in an appropriate order. Furthermore, the information processing apparatus 10 may change the order in which the respective indexes are optimized. That is, the information processing apparatus 10 may receive, from the user, a designation of an order in which the feature of the learning data to be learned by the model, the structure of the model to be generated, and the training mode used when the model is trained with the feature of the learning data are determined, and determine the respective indexes in the designated order.

For example, when the generation of the generation index is started, the information processing apparatus 10 performs optimization of an input feature such as optimization of the feature of the learning data to be input and the manner in which the learning data is input, and subsequently performs optimization of an input cross feature such as optimization of features of a combination of the features to be learned. Then, the information processing apparatus 10 selects the model and optimizes the model structure. Thereafter, the information processing apparatus 10 optimizes the hyperparameter and ends the generation of the generation index.

Here, in the input feature optimization, the information processing apparatus 10 may repeatedly perform the optimization of the input feature by selecting and correcting various input features such as the feature of the learning data to be input and the input manner and selecting a new input feature by using the genetic algorithm. Similarly, in the input cross feature optimization, the information processing apparatus 10 may repeatedly perform the optimization of the input cross feature, and may repeatedly perform the model selection and the model structure optimization. Furthermore, the information processing apparatus 10 may repeatedly perform the hyperparameter optimization. Furthermore, the information processing apparatus 10 may repeatedly perform a series of processing including the input feature optimization, the input cross feature optimization, the model selection, the model structure optimization, and the hyperparameter optimization to optimize each index.

For example, the information processing apparatus 10 may perform the model selection and the model structure optimization after performing the hyperparameter optimization, or may perform the input feature optimization and the input cross feature optimization after the model selection and the model structure optimization. Furthermore, for example, the information processing apparatus 10 repeatedly performs the input feature optimization, and then repeatedly performs the input cross feature optimization. Thereafter, the information processing apparatus 10 may repeatedly perform the input feature optimization and the input cross feature optimization. In this manner, arbitrary setting can be adopted as to which index is to be optimized in which order and which optimization processing is to be repeatedly performed in the optimization.

[3-4. Flow of Model Generation Implemented by Information Processing Apparatus]

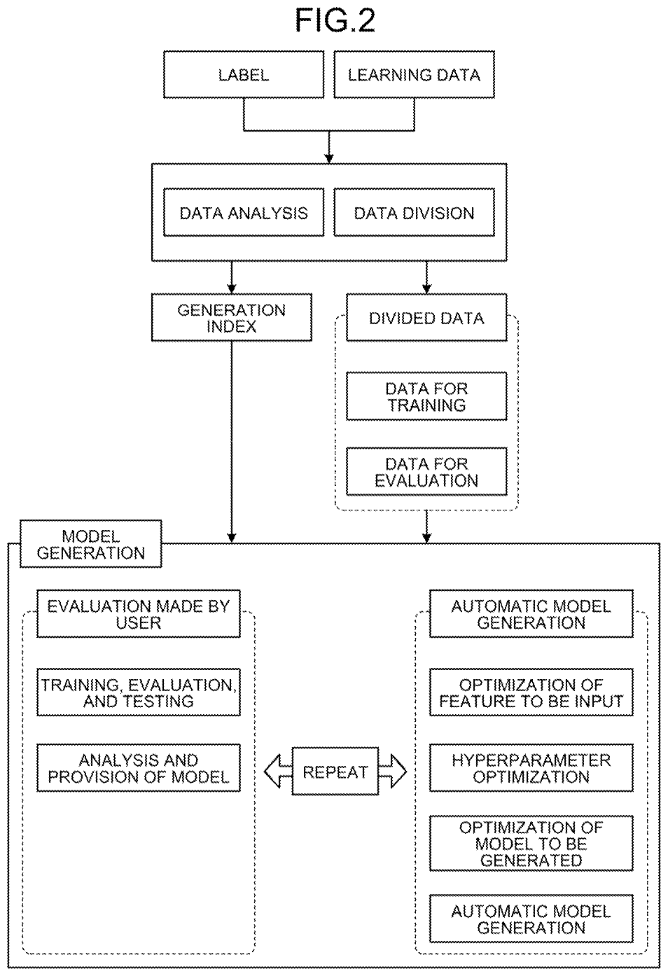

Next, an example of a flow of the model generation using the information processing apparatus 10 will be described with reference to FIG. 2. FIG. 2 is a diagram illustrating the example of the flow of the model generation using the information processing apparatus according to the embodiment. For example, the information processing apparatus 10 receives learning data and a label assigned to each piece of learning data. Note that the information processing apparatus 10 may receive the label together with a designation of the learning data.

In such a case, the information processing apparatus 10 performs data analysis and performs data division based on the analysis result. For example, the information processing apparatus 10 divides the learning data into data for training used for the training of the model and data for evaluation used for the evaluation of the model (that is, measurement of accuracy). Note that the information processing apparatus 10 may further divide data for various tests. Note that, as processing of dividing such learning data into the data for training and the data for evaluation, various known technologies can be adopted.

Furthermore, the information processing apparatus 10 generates the above-described various generation indexes by using the learning data. For example, the information processing apparatus 10 generates a configuration file that defines a model to be generated and training of the model in AutoML. In such a configuration file, various functions used in AutoML are stored as they are, as information indicating the generation index. Then, the information processing apparatus 10 performs the model generation by providing the data for training and the generation index to the model generation server 2.

Here, by repeatedly causing the user to perform the model evaluation and performing the automatic generation of the model, the information processing apparatus 10 may achieve the optimization of the generation index and eventually the optimization of the model. For example, the information processing apparatus 10 optimizes a feature to be input (performs the input feature optimization and the input cross feature optimization), optimizes a hyperparameter, and optimizes a model to be generated, and automatically generates a model according to the optimized generation index. Then, the information processing apparatus 10 provides the generated model to the user.

Meanwhile, the user performs training, evaluation, and testing of the automatically generated model, and analyzes and provides the model. Then, the user corrects the generated generation index to automatically generate a new model again, and performs the evaluation, testing, and the like. By repeatedly performing such processing, it is possible to implement processing for improving the accuracy of the model while undergoing trial and error without performing complicated processing.

### [4. Configuration of Information Processing Apparatus]

Next, an example of a functional configuration of the information processing apparatus 10 according to the embodiment will be described with reference to FIG. 3. FIG. 3 is a diagram illustrating a configuration example of the information processing apparatus according to the embodiment. As illustrated in FIG. 3, the information processing apparatus 10 includes a communication unit 20, a storage unit 30, and a control unit 40.

The communication unit 20 is implemented by, for example, a network interface card (NIC) or the like. Then, the communication unit 20 is connected to the network N in a wired or wireless manner, and transmits and receives information to and from the model generation server 2 and the terminal apparatus 3.

The storage unit 30 is implemented by, for example, a semiconductor memory element such as a random access memory (RAM) or a flash memory, or a storage device such as a hard disk or an optical disk. In addition, the storage unit 30 includes a learning data database 31 and a model generation database 32.

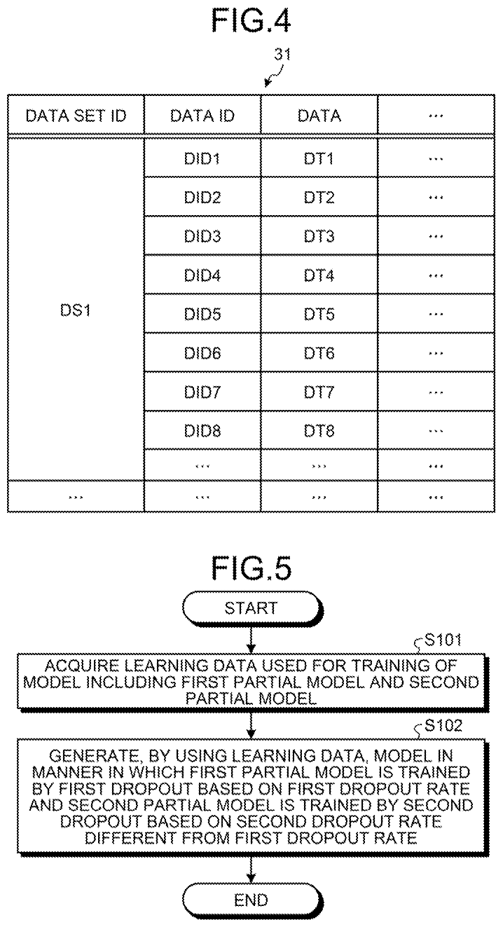

The learning data database 31 stores various pieces of information regarding data used for training. The learning data database 31 stores a data set of the learning data used for the training of the model. FIG. 4 is a diagram illustrating an example of information registered in the learning data database according to the embodiment. In the example of FIG. 4, the learning data database 31 includes items such as “data set ID”, “data ID”, and “data”.

The “data set ID” indicates identification information for identifying the data set. The “data ID” indicates identification information for identifying each piece of data. The “data” indicates data identified by the data ID. For example, in the example of FIG. 4, corresponding data (learning data) is registered in association with a data ID for identifying each piece of learning data.

In the example of FIG. 4, a data set (data set DS1) identified by a data set ID “DS1” includes a plurality of pieces of data “DT1”, “DT2”, “DT3”, and the like identified by data IDs “DID1”, “DID2”, “DID3”, and the like. Note that, in FIG. 4, the data is indicated by an abstract character string such as “DT1”, “DT”, or “DT3”, but information in an arbitrary format such as various integers, floating point numbers, or character strings is registered as the data.

Note that, although not illustrated, the learning data database 31 may store a label (correct answer information) corresponding to each piece of data in association with each piece of data. In addition, for example, one label may be stored in association with a data group including a plurality of pieces of data. In this case, the data group including a plurality of pieces of data corresponds to data (input data) input to the model. For example, information in an arbitrary format such as a numerical value or a character string is used as the label.

Note that the learning data database 31 is not limited to the above, and may store various pieces of information depending on a purpose. For example, the learning data database 31 may store data in a manner in which whether the data is data used for training processing (data for training) or data used for evaluation (data for evaluation) can be specified. For example, the learning data database 31 may store information (a flag or the like) specifying whether each piece of data is data for training or data for evaluation in association with each piece of data.

The model generation database 32 stores various pieces of information used for model generation other than the learning data. The model generation database 32 stores various pieces of information regarding the model to be generated. For example, the model generation database 32 stores information used to determine the size of the model according to the dropout rate. For example, the model generation database 32 stores a function (for example, a function FC11 in FIG. 14) indicating a relationship between the dropout rate and a unit size.

For example, the model generation database 32 stores setting values such as various parameters related to the model to be generated. The model generation database 32 stores information indicating the structure of the model, such as the number of partial models included in the model to be generated and information regarding each partial model.

For example, the model generation database 32 stores information indicating the type of each partial model. For example, the model generation database 32 stores information indicating whether or not each partial model includes the hidden layer. For example, in a case where the partial model is the first-type partial model that does not include the hidden layer, information indicating the first type is stored in the model generation database 32 in association with the partial model. For example, in a case where the partial model is the second-type partial model that includes the hidden layer, information indicating the second type is stored in the model generation database 32 in association with the partial model.

For example, the model generation database 32 stores information indicating the size of the hidden layer included in each partial model. For example, the model generation database 32 stores each partial model in association with the unit size (the number of nodes or the like) of the hidden layer included in the partial model.

) Note that the model generation database 32 is not limited to the above, and may store various pieces of model information as long as the information is used to generate the model.

Referring back to FIG. 3, the description will be continued. The control unit. 40 is implemented by, for example, a central processing unit (CPU), a micro processing unit (MPU), or the like executing various programs (for example, a generation program that performs processing of generating a model and an information processing program) stored in a storage device inside the information processing apparatus 10 using a RAM as a work area. The information processing program is used to operate a computer as a model including a first partial model and a second partial model. For example, the information processing program causes a computer (for example, the information processing apparatus 10) to operate as the model that has been trained with the learning data by training the first partial model by dropout based on a first dropout rate and training the second partial model by dropout based on a second dropout rate different from the first dropout rate. In addition, the control unit 40 is implemented by, for example, an integrated circuit such as an application specific integrated circuit. (ASIC) or a field programmable gate array (FPGA). As illustrated in FIG. 3, the control unit 40 includes an acquisition unit 41, a determination unit 42, a reception unit 43, a generation unit 44, and a provision unit 45.

The acquisition unit 41 acquires information from the storage unit 30. The acquisition unit 41 acquires a data set of the learning data used for the training of the model. The acquisition unit 41 acquires the learning data used for the training of the model. For example, when once various pieces of data to be used as the learning data and labels assigned to the various pieces of data are received from the terminal apparatus 3, the acquisition unit 41 registers the received data and labels in the learning data database 31 as the learning data. Note that the acquisition unit 41 may receive a designation of a learning data ID or a label of the learning data used for the training of the model among the pieces of data registered in the learning data database 31 in advance.

The acquisition unit 41 acquires the learning data used for the training of the model including the first partial model and the second partial model. The acquisition unit 41 acquires information indicating the dropout rate. The acquisition unit. 41 acquires information indicating the first dropout rate. The acquisition unit 41 acquires information indicating the second dropout rate.

The determination unit 42 determines the training mode. The determination unit 42 determines the dropout rate. The determination unit 42 determines the dropout rate of each partial model. The determination unit 42 determines the size of the model. The determination unit 42 determines the unit size of the hidden layer included in the second-type partial model.

The reception unit 43 receives correction of the generation index presented to the user. In addition, the reception unit 43 receives, from the user, a designation of the order in which the feature of the learning data to be learned by the model, the structure of the model to be generated, and the training mode used when the model is trained with the feature of the learning data are determined.

The generation unit 44 generates various pieces of information according to the determination made by the determination unit 42. In addition, the generation unit 44 generates various pieces of information according to an instruction received by the reception unit 43. For example, the generation unit 44 may generate the model generation index.

The generation unit 44 generates, by using the learning data, a model in a manner in which the first partial model is trained by first dropout based on the first dropout rate and the second partial model is trained by second dropout based on the second dropout rate different from the first dropout rate. The generation unit 44 generates the model including the second partial model including a larger number of layers than the first partial model. The generation unit 44 generates the model including the second partial model including the hidden layer.

The generation unit 44 generates the model which includes the input layer to which the learning data is input and in which an output from the input layer is input to each of the first partial model and the second partial model. The generation unit 44 generates the model including an embedding layer in which an input is embedded. The generation unit 44 generates the model including the first partial model including a first embedding layer in which an input from the input layer is embedded. The generation unit 44 generates the model including the second partial model including a second embedding layer in which an input from the input layer is embedded.

The generation unit 44 generates the model including a combining layer that combines an output from the first partial model and an output from the second partial model. The generation unit 44 generates the model including the first partial model including a first output layer whose output is input to the combining layer. The generation unit 44 generates the model including the second partial model including a second output layer whose output is input to the combining layer. The generation unit 44 generates the model including the combining layer including a softmax layer. The generation unit 44 generates the model including the combining layer that performs combining processing for the output of the first partial model and the output of the second partial model before the softmax layer.

The generation unit 44 generates the model by performing batch normalization after dropout based on the dropout rate. The generation unit 44 generates the model by performing batch normalization after the first dropout for training. The generation unit 44 generates the model by performing batch normalization after the second dropout for training.

The generation unit 44 generates the model having a size based on the dropout rate. The generation unit 44 generates the model including the first partial model having a size based on the first dropout rate. The generation unit 44 generates the model including the second partial model having a size based on the second dropout rate. The generation unit 44 generates the model including the second partial model that includes the hidden layer based on the second dropout rate. The generation unit 44 generates the model including the second partial model that includes the hidden layer having a size determined based on the second dropout rate.

The generation unit 44 generates the model including the hidden layer having a size determined based on the dropout rate. The generation unit 44 generates the model including the hidden layer having a size determined based on a correlation between the dropout rate and the size of the hidden layer. The generation unit 44 generates the model based on a positive correlation between the dropout rate and the size of the hidden layer. The generation unit 44 generates the model including the hidden layer having a size determined using a function having the dropout rate and the size of the hidden layer as variables.

The generation unit 44 generates the model based on a target size which is the size of the hidden layer corresponding to the dropout rate specified based on the function. The generation unit 44 generates the model including the hidden layer having a size within a predetermined range from the target size. The generation unit 44 generates the model including the hidden layer having a size with the highest accuracy among a plurality of sizes within a predetermined range from the target size. The generation unit 44 trains a plurality of models corresponding to a plurality of sizes within a predetermined range from the target size, respectively, and generates one model having the highest accuracy among the plurality of models as the model.

The generation unit 44 requests the model generation server 2 to train a model by transmitting data used for model generation to the external model generation server 2, and receives the model trained by the model generation server 2 from the model generation server 2, thereby generating the model.

For example, the generation unit 44 generates the model by using the data registered in the learning data database 31. The generation unit 44 generates the model based on each piece of data used as the data for training, and the label. The generation unit 44 generates the model by performing training so that an output result output from the model when the data for training is input matches the label. For example, the generation unit 44 causes the model generation server 2 to train the model by transmitting each piece of data used as the data for training and the label to the model generation server 2, thereby generating the model.

For example, the generation unit 44 measures the accuracy of the model by using the data registered in the learning data database 31. The generation unit 44 measures the accuracy of the model based on each piece of data used as the data for evaluation and the label. The generation unit 44 measures the accuracy of the model by collecting a result of comparing the label with the output result output from the model in a case where the data for evaluation is input.

The provision unit 45 provides the generated model to the user. The provision unit 45 transmits the information processing program for causing the terminal apparatus 3 of the user to be operated as a model (for example, a model M1) including a plurality of partial models to the terminal apparatus 3 of the user. For example, in a case where the accuracy of the model generated by the generation unit 44 exceeds a predetermined threshold, the provision unit 45 transmits the model and the generation index corresponding to the model to the terminal apparatus 3. As a result, the user can perform correction of the generation index, in addition to evaluation and testing of the model.

The provision unit 45 presents the index generated by the generation unit 44 to the user. For example, the provision unit 45 transmits a configuration file of AutoML generated as the generation index to the terminal apparatus 3. Furthermore, the provision unit 45 may present the generation index to the user every time the generation index is generated, and for example, may present only the generation index corresponding to the model whose accuracy exceeds the predetermined threshold to the user.

### [5. Processing Flow of Information Processing System]

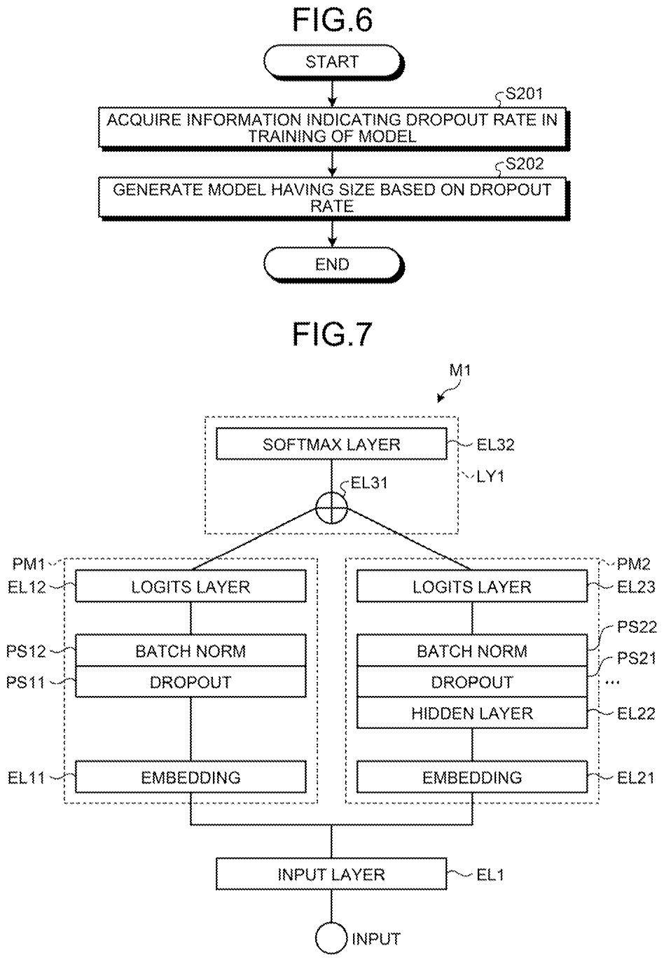

Next, a procedure of processing performed by the information processing apparatus 10 will be described with reference to FIGS. 5 and 6. FIGS. 5 and 6 are flowcharts illustrating an example of a flow of the information processing according to the embodiment. Furthermore, in the following, a case where the information processing system 1 performs the processing will be described as an example, but the following processing may be performed by any apparatus included in the information processing system 1, such as the information processing apparatus 10, the model generation server 2, and the terminal apparatus 3 included in the information processing system 1.

An outline of a flow of processing of generating a model by setting the dropout rate for each partial model in the information processing system 1 will be described with reference to FIG. 5. In FIG. 5, the information processing system 1 acquires the learning data used for training of a model including the first partial model and the second partial model (Step S101). Then, the information processing system 1 generates, by using the learning data, the model in a manner in which the first partial model is trained by the first dropout based on the first dropout rate and the second partial model is trained by the second dropout based on the second dropout rate different from the first dropout rate (Step S102).

Next, an outline of a flow of processing of generating a model by setting the size according to the dropout rate in the information processing system 1 will be described with reference to FIG. 6. For example, the information processing system 1 generates a model by setting the size of the hidden layer based on the dropout rate for the second-type partial model. In FIG. 6, the information processing system 1 acquires information indicating the dropout rate in training of a model (Step S201). For example, the information processing system 1 acquires information indicating the dropout rate of the second-type partial model in the training of the model. Then, the information processing system 1 generates the model having a size based on the dropout rate (Step S202). For example, the information processing system 1 determines the unit size of the hidden layer of the second-type partial model based on the dropout rate, and generates a model including the second-type partial model having the determined unit size.

Note that the information processing system 1 may determine the size of the first-type partial model based on the dropout rate. The information processing system 1 may determine the unit size of the embedding layer of the first-type partial model based on the dropout rate. For example, the information processing system 1 may increase the unit size of the embedding layer of the first-type partial model as the dropout rate increases. The information processing system 1 may determine the unit size of the embedding layer of the first-type partial model by using a function indicating a relationship between the dropout rate and the unit size of the embedding layer. For example, the information processing apparatus 10 may acquire information indicating the dropout rate of the first-type partial model included in the model, and determine the unit size of the embedding layer of the first-type partial model based on the information. Similarly, for example, the information processing system 1 may determine the unit size of the embedding layer of the first-type partial model based on the dropout rate.

### [6. Processing Example of Information Processing System]

Here, an example in which the information processing system 1 performs the processing of FIGS. 5 and 6 described above will be described. The information processing apparatus 10 acquires the learning data. The information processing apparatus 10 acquires information such as a parameter used for generating the model. For example, the information processing apparatus 10 acquires information indicating the dropout rate of the first-type partial model included in the model and information indicating the dropout rate of the second-type partial model. Note that, in a case where there are a plurality of first-type partial models, the information processing apparatus 10 acquires information indicating the dropout rate of each of the first-type partial models. Furthermore, in a case where there are a plurality of second-type partial models, the information processing apparatus 10 acquires information indicating the dropout rate of each of the second-type partial models.

Furthermore, the information processing apparatus 10 determines the unit size (the number of nodes) of the hidden layer based on the dropout rate for the second-type partial model. For example, the information processing apparatus 10 determines the unit size of the hidden layer by using a function (for example, the function FC11 in FIG. 14) indicating the relationship between the dropout rate and the unit size for the second-type partial model.

Note that the information processing system 1 may repeat the training of the model while adjusting the unit size of the hidden layer based on the function (for example, the function FC11 in FIG. 14) and determine the unit size of the hidden layer at which the accuracy is improved.

The information processing apparatus 10 transmits information used for generating the model to the model generation server 2 that trains the model. For example, the information processing apparatus 10 transmits the learning data, the information indicating the structure of the model, and the information indicating the dropout rate of each partial model to the model generation server 2.

The model generation server 2 that has received the information from the information processing apparatus 10 generates the model by performing the training processing. Then, the model generation server 2 transmits the generated model to the information processing apparatus 10. As described above, “generating a model” in the present application is not limited to a case where the own device trains a model, and is a concept including a case of providing information necessary for generating a model to another apparatus to instruct the another apparatus to generate the model, and receiving the model trained by the another apparatus. In the information processing system 1, the information processing apparatus 10 transmits the information used for generating the model to the model generation server 2 that trains the model and acquires the model generated by the model generation server 2, thereby generating the model. In this manner, the information processing apparatus 10 requests the generation of the model by transmitting the information used for generating the model to another apparatus, and causing the another apparatus that has received the request to generate the model, thereby generating the model.

### [7. Model]

Hereinbelow, the model will be described. Hereinafter, each point regarding the model such as the structure and training mode for the model generated in the information processing system 1 will be described.

### [7-1. Example of Structure of Model]

First, an example of the structure of the generated model will be described with reference to FIG. 7. The information processing system 1 generates the model M1 as illustrated in FIG. 7. FIG. 7 is a diagram illustrating an example of the structure of the model according to the embodiment.

In FIG. 7, an input layer EL1 indicated as “Input Layer” indicates a layer to which input information is input. Information (input information) indicated as “Input” in FIG. 7 is input to the input layer EL1. The input layer EL1 is followed by two partial models arranged in parallel, the two partial models including a partial model PM1 that is the first-type partial model and a partial model PM2 that is the second-type partial model. As illustrated in FIG. 7, the plurality of partial models are connected in parallel.

The partial model PM1 includes an embedding layer EL11 indicated as “Embedding” in FIG. 7. The embedding layer EL11 is the first embedding layer in which an input from the input layer EL1 is embedded. The embedding layer EL11 vectorizes (embeds) the information acquired from the input layer EL1. The embedding layer EL11 corresponds to an input layer of the partial model PM1.

In addition, the partial model PM1 includes a logits layer EL12 denoted as “Logits Layer” in FIG. 7. The logits layer EL12 is the last layer of the partial model PM1, and generates information (value) to be output to a combining layer LY1 including a softmax layer EL32 to be described later. The logits layer EL12 corresponds to an output layer of the partial model PM1. For example, the embedding layer EL11 and the logits layer EL12 are directly fully connected.

Dropout PS11 and batch normalization PS12 illustrated between the embedding layer EL11 and the logits layer EL12 in FIG. 7 indicate a training mode for the partial model PM1. The dropout PS11 indicated as “Dropout” in FIG. 7 indicates the first dropout which is dropout processing performed for the partial model PM1. The dropout PS11 is performed for the embedding layer EL11 and the logits layer EL12 at the time of training.

In addition, the batch normalization PS12 is performed after the dropout PS11. For example, the batch normalization PS12 is performed following a layer on which the dropout PS11 has been performed. That is, the batch normalization PS12 is performed on those (nodes) randomly activated by the dropout in the dropout PS11. As a result, in back propagation or the like at the time of the training of the model, it is possible to suppress one that is not a training target, such as a node that is not activated, from being subjected to the batch normalization. That is, in back propagation or the like at the time of training of the model M1, it is possible to suppress one that is not a training target, such as a node that is not activated by the dropout PS1i, from being subjected to the batch normalization PS12.

The partial model PM2 includes an embedding layer EL21 indicated as “Embedding” in FIG. 7. The embedding layer EL21 is the second embedding layer in which an input from the input layer EL1 is embedded. The embedding layer EL21 vectorizes (embeds) the information acquired from the input layer ELL. The embedding layer EL21 corresponds to an input layer of the partial model PM2.

The partial model PM2 includes a hidden layer EL22 indicated as “Hidden Layer” in FIG. 7. The hidden layer EL22 is a hidden layer (intermediate layer) arranged between the embedding layer EL21 and a logits layer EL23. As illustrated in FIG. 7, the embedding layer EL21 and the hidden layer EL22 are connected, and an output of the embedding layer EL21 is input to the hidden layer EL22. The number of layers of the partial model PM2 is set larger than that of the partial model PM1.

In addition, the partial model PM12 includes the logits layer EL23 indicated as “Logits Layer” in FIG. 7. The logits layer EL23 is the last layer of the partial model PM2, and generates information (value) to be output to the combining layer LY1 including the softmax layer EL32 to be described later. The logits layer EL23 corresponds to an output layer of the partial model PM2. As illustrated in FIG. 7, the hidden layer EL22 and the logits layer EL23 are connected, and an output of the hidden layer EL22 is input to the logits layer EL23.

Dropout PS21 and batch normalization PS22 illustrated between the hidden layer EL22 and the logits layer EL23 in FIG. 7 indicate a training mode for the partial model PM2. The dropout PS21 indicated as “Dropout” in FIG. 7 indicates the second dropout which is dropout processing performed for the partial model PM2. The dropout PS21 is performed for the hidden layer EL22 and the logits layer EL23 at the time of training.

For example, the batch normalization PS22 is performed following a layer on which the dropout PS2i has been performed. That is, the batch normalization PS22 is performed on those (nodes) randomly activated by the dropout in the dropout PS21. As a result, in back propagation or the like at the time of the training of the model, it is possible to suppress one that is not a training target, such as a node that is not activated, from being subjected to the batch normalization. That is, in back propagation or the like at the time of training of the model M1, it is possible to suppress one that is not a training target, such as a node that is not activated by the dropout PS21, from being subjected to the batch normalization PS22. Note that the order of the hidden layer EL22, the dropout PS21, and the batch normalization PS22 may be appropriately changed depending on the data type or convergence time.

The output of the partial model PM1 and the output of the partial model PM2 are input to the combining layer LY1. The combining layer LY1 includes a combining processing layer EL31 that combines the output of the partial model PM1 and the output of the partial model PM2, and the softmax layer EL32. The combining layer LY1 may be an output layer of the model M1.

The combining processing layer EL31 calculates an average of the output of the partial model PM1 and the output of the partial model PM2. For example, the combining processing layer EL31 generates information (combined output) obtained by combining each output of the partial model PM1 and the output of the partial model PM2 by calculating an average of each output of the partial model PM1 and each corresponding output of the partial model PM2.

The softmax layer EL32 indicated as “Softmax Layer” in FIG. 7 performs softmax processing. The softmax layer EL32 performs the softmax processing for the combined output generated by the combining processing layer EL31. The softmax layer EL32 converts the value of each output so that the sum of the outputs becomes 100% (1).

Note that the above-described configuration is merely an example, and any configuration can be adopted for the model as long as a plurality of partial models are included. For example, FIG. 7 illustrates a case where the number of partial models is two, that is, one first-type partial model and one second-type partial model are included, but the number of partial models is not limited to two. For example, the model may include two or more second-type partial models, or may include two or more first-type partial models.

As described above, the dropout rate is set for each partial model, but in the information processing system 1, the training is performed on one model M1. The information processing system 1 performs back propagation as a whole to update a parameter (weight) of the model M1 and generate the model M1. For example, the information processing system 1 sets an initial value of the weight by using an initializer of the weight. Note that a random seed (for example, tf_random_seed) of the initializer of the weight is optimized. For example, the optimization of the random seed of the initializer of the weight may be performed by finding the initial value of the weight that can decrease a parameter (for example, k(w_{c})) in a neural tangent kernel (NTK) theory. The optimization of the random seed of the initializer of the weight is not limited to the above, and may be performed by an arbitrary technique. For example, the information processing system 1 sets the initial value of the weight by the initializer of the weight using the optimized random seed. As described above, the information processing system 1 can improve the accuracy of the model to be generated by setting the initial value of the weight using the initializer of the weight in which the random seed is optimized.

For example, the information processing system 1 performs the training processing in a state where the dropout PS11 is performed for the partial model PM1, and updates the parameter (weight) of the model M1. The information processing system 1 performs the training processing in a state where the dropout PS11 is performed for the partial model PM1 and performs the back propagation as a whole to update the parameter (weight) of the model M1, thereby generating the model M1. In this case, for example, the information processing system 1 may perform the batch normalization PS22 in a network configuration in a state in which the dropout PS21 is not performed for the partial model PM2 to update the parameter (weight) of the model M1.

Furthermore, for example, the information processing system 1 performs the training processing in a state where the dropout PS21 is performed for the partial model PM2 to update the parameter (weight) of the model M1. In this case, the information processing system 1 performs the training processing in a state where the dropout PS21 is performed for the partial model PM2 and performs the back propagation as a whole to update the parameter (weight) of the model M1, thereby generating the model M1. For example, the information processing system 1 may perform the batch normalization PS12 in a network configuration in a state in which the dropout PS11 is not performed for the partial model PM1 to update the parameter (weight) of the model M1.

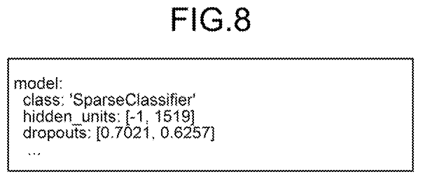

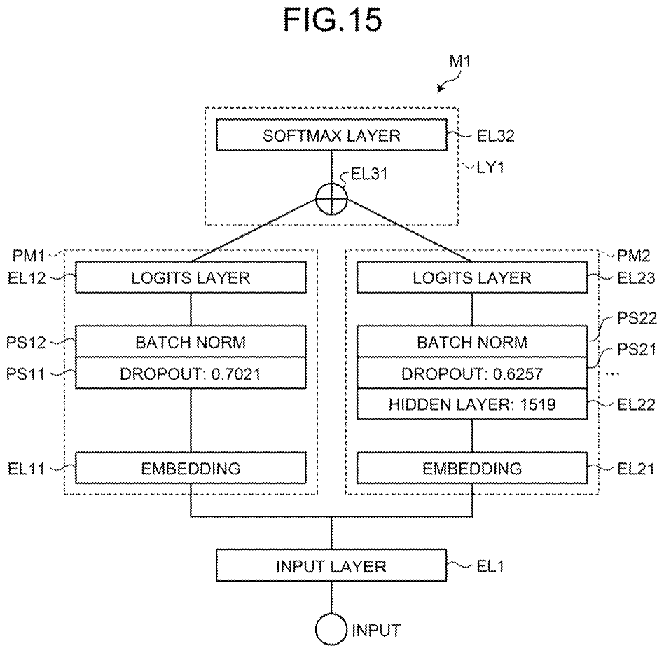

Next, an example of the parameter to be set will be described with reference to FIG. 8. The information processing system 1 generates the model M1 based on a parameter as illustrated in FIG. 8. FIG. 8 is a diagram illustrating an example of the parameter according to the embodiment. For example, the parameter illustrated in FIG. 8 corresponds to the parameter in the generation of the model M1 illustrated in FIG. 15.

In this manner, the information processing system 1 may individually perform the dropout for each of the partial models PM1 and PM2 to train them as one model M1. In addition, the information processing system 1 may train the partial models PM1 and PM2 as one model M1 in a state where the dropout is performed for both the partial models PM1 and PM2. The information processing system 1 may perform the back propagation as a whole in a state where the dropout is performed for both the partial models PM1 and PM2 to update the parameter (weight) of the model M1, thereby generating the model M1.

FIG. 8 illustrates a case where a model configuration including two partial models is designated. The first partial model in FIG. 8 is a partial model in which “hidden_units” is “−1” and which does not include the hidden layer. That is, the first partial model in FIG. 8 is the first-type partial model. The dropout rate of the first partial model in FIG. 8 is set to “0.7021”.

The second partial model in FIG. 8 is a partial model in which “hidden_units” is “1519”, that is, the unit size (the number of nodes) of the hidden layer is designated as 1519. That is, the second partial model in FIG. 8 is the second-type partial model. The dropout rate of the second partial model in FIG. 8 is set to “0.6257”.

### [7-2. Dropout]

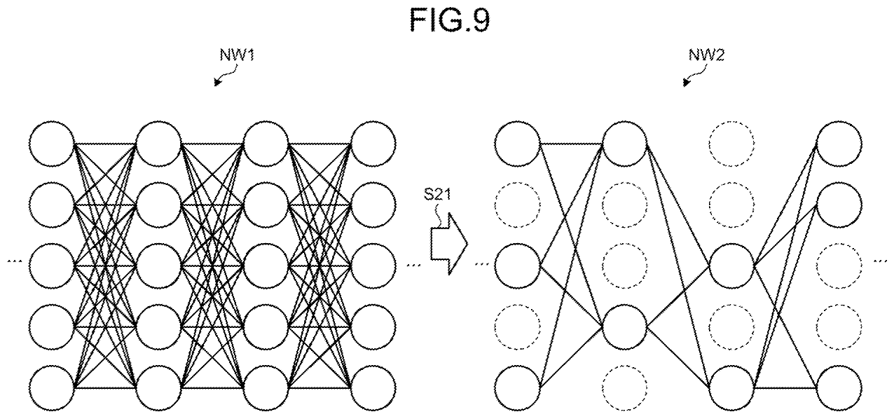

Here, an outline of the dropout performed in the processing in the dropout PS11 and the dropout PS12 in FIG. 7 will be described. FIG. 9 is a diagram illustrating a concept of the dropout according to the embodiment.

A model network NW1 illustrated in FIG. 9 is a part of the network of the model before the dropout is performed. Note that, although FIG. 9 illustrates a case where the connection is fully connected for convenience of explanation, the network configuration of the model is not limited to the full connection. Each circle in the model network NW1 indicates a unit (node), and respective circles connected by a line are connected. FIG. 9 illustrates four layers each including five nodes. That is, FIG. 9 illustrates 20 nodes in the model network NW1, and illustrates a state in which five nodes of each layer are arranged along a vertical direction and the respective layers are arranged in a horizontal direction.

A model network NW2 illustrated in FIG. 9 is a part of the network of the model in a state in which the dropout is performed. In FIG. 9, the dropout rate is set to 0.5, and the dropout is performed on the model including the model network NW1 (Step S21).

Among the 20 nodes in the model network NW2, a dotted circle indicates a node invalidated by the dropout, that is, a node that is not activated. FIG. 9 illustrates a state in which 10 nodes, which correspond to half of the 20 nodes, are invalidated since the dropout rate is 0.5. Among the 20 nodes in the model network NW2, a solid circle, that is, a circle that is not changed from the model network NW1, indicates a node that is not invalidated by the dropout, that is, a node that is activated.

As described above, in the training mode using the dropout, training is performed after some nodes are invalidated by the dropout. In the training mode using the dropout, many nodes are invalidated and training is repeated by changing the nodes to be invalidated in a predetermined cycle.

Note that the dropout processing is processing (technology) used in training of the neural network, and a detailed description thereof will be omitted. In addition, in the following findings and the like, the accuracy can be improved by setting the dropout rate to a value larger than 0.5, which will be described later.

### [7-3. Batch Normalization]

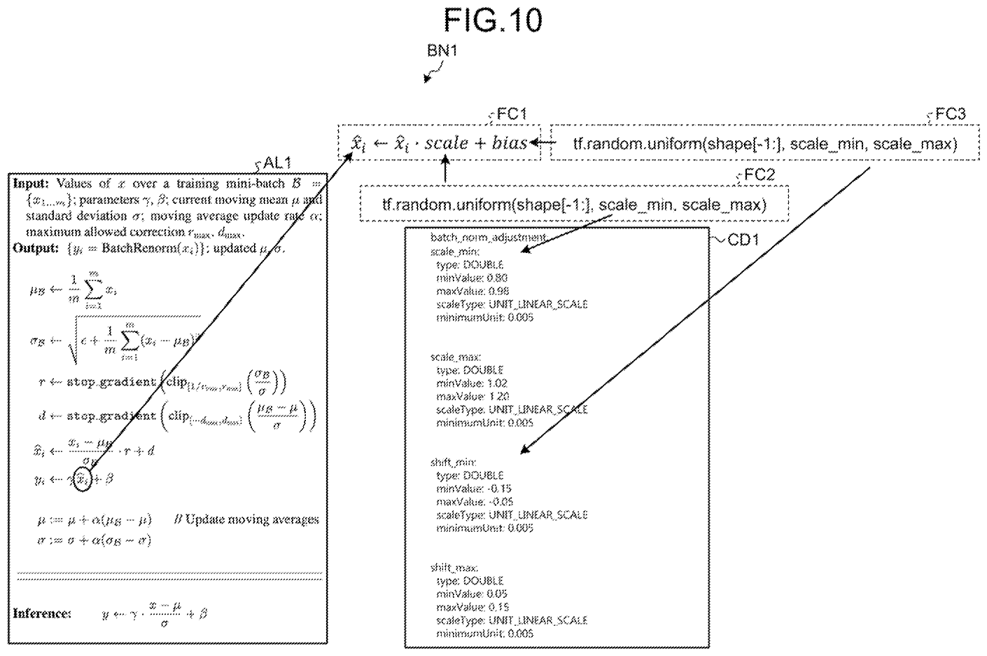

Next, an outline of the batch normalization performed in the batch normalization PS12 or the batch normalization PS22 in FIG. 7 will be described. FIG. 10 is a diagram illustrating a concept of the batch normalization according to the embodiment. An overall image BN1 of FIG. 10 depicts an outline of the batch normalization. An algorithm AL1 in FIG. 10 indicates an algorithm related to the batch normalization. A function FC1 in FIG. 10 indicates a function for applying the batch normalization.

The function FC1 indicates an example of a function that normalizes an input (that is, an output of a previous layer) by using parameters “scale” and “bias”. The left side of an arrow (←) in the function FC1 indicates a value after the normalization, and the right side of the arrow (←) in the function FC1 is calculated by multiplying the value before the normalization by the parameter “scale” and adding the parameter “bias”. In this manner, in the example of FIG. 10, the normalization is performed by using the parameters “scale” and “bias”. Specifically, by the function FC1, the normalization is performed in a manner in which the value before the normalization is multiplied by the value of the parameter “scale” and the value of the parameter “bias” is added to the multiplication result.

In the example of FIG. 10, upper limit values and lower limit values of the parameters “scale” and “bias” are defined by a code CD1. The value of the parameter “scale” is determined by the code CD1 and a function FC2. For example, the function FC2 is a function that generates a random number in a range with “scale_min” as a lower limit and “scale_max” as an upper limit.

The value of the parameter “bias” is determined by the code CD1 and a function FC3. For example, the function FC3 is a function that generates a random number in a range with “shift_min” as a lower limit and “shift_max” as an upper limit.

In the example of FIG. 10, the batch normalization is performed using the function FC1. For example, in the information processing system 1, the batch normalization PS12 is performed following a layer on which the dropout PS11 has been performed. In addition, in the information processing system 1, the batch normalization PS22 is performed following a layer on which the dropout PS21 has been performed. As a result, in back propagation or the like at the time of the training of the model, the information processing system can suppress one that is not a training target, such as a node that is not activated, from being subjected to the batch normalization.

For example, in a case where an application programming interface (API) for the model generation server 2 to receive a designation of the batch normalization is provided, the information processing apparatus 10 may instruct the model generation server 2 to perform the batch normalization by using the API.

### [8. Findings and Experimental Results]

Hereinbelow, findings and experimental results obtained based on the model generated by the above-described processing are described.

### [8-1. First Finding]

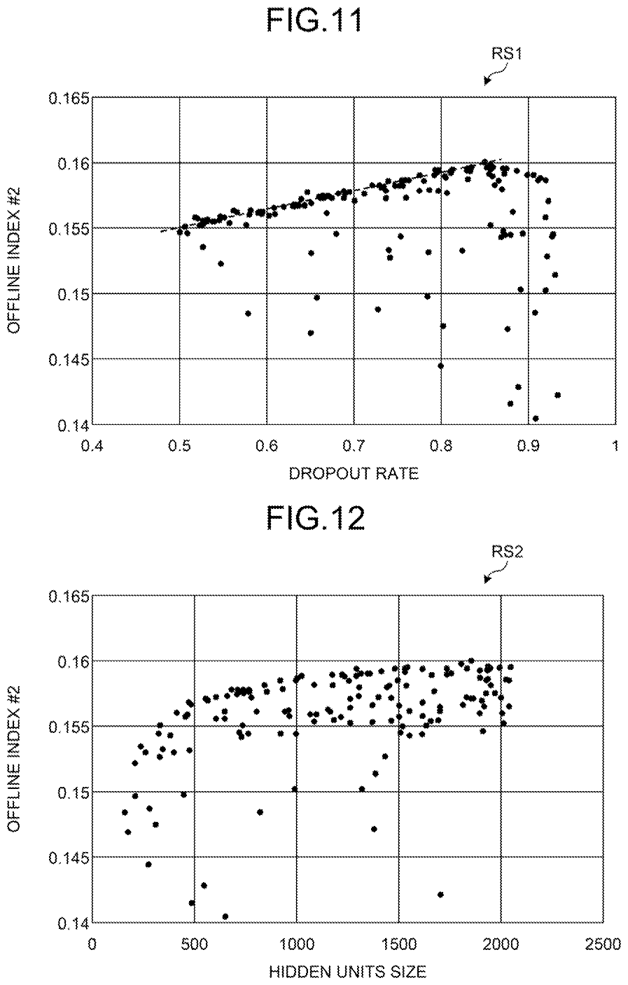

First, a first finding will be described with reference to FIG. 11. FIG. 11 is a graph related to the first finding. Specifically, a horizontal axis of a graph RS1 of FIG. 11 represents the dropout rate, and a vertical axis represents the accuracy. The first finding is a finding obtained for a relationship between the dropout rate and the accuracy by an experiment (measurement).

Fox example, the first finding is a finding in a case where a model (hereinafter, also referred to as a “target model”) for recommending a lodging facility based on a behavior of the user is generated, and the accuracy of the model (target model) is measured. Here, the target model is a model that outputs a score of each of a large number of target lodging facilities (also referred to as “target lodging facilities”), for example, tens of thousands of target lodging facilities, in a case where behavior data of the user is input.

FIG. 11 illustrates a case where an index serving as a reference of the accuracy of the model is an “offline index #2”. An experimental result illustrated in FIG. 11 is obtained by averaging a reciprocal of the highest ranking of the lodging facility actually browsed by the user in a case where the behavior data of the user is input to the model and rankings of lodging facilities are determined in descending order of scores output by the model by the offline index #2. That is, the offline index #2 is obtained by averaging the reciprocal of the ranking of the lodging facility that has been actually browsed by the user and first appears in a list sorted in descending order of score output by the model. For example, in a case where the ranking of the lodging facility that has been actually browsed by the user and first appears is “2”, the offline index #2 is “0.5 (=½)”.

The graph RS1 of FIG. 11 indicates that there is a high correlation between the dropout rate and the accuracy. In the graph RS1 of FIG. 11, for example, when the dropout rate is between 0.5 and 0.9, there is a positive correlation between the dropout rate and the accuracy as indicated by a dotted line in the graph RS1.

FIG. 11 illustrates a result obtained by fixing the dropout rate and adjusting the unit size of the hidden layer. The result shows that the accuracy of the model was improved by adjusting the unit size of the hidden layer while increasing the dropout rate.

### [8-2. Second Finding]

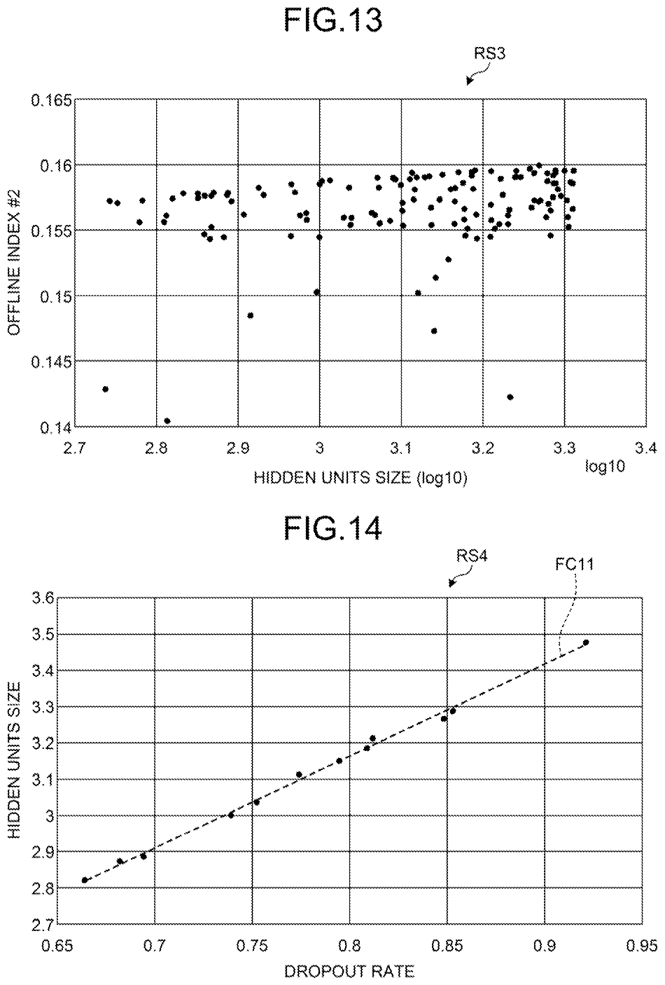

Next, a second finding will be described with reference to FIGS. 12 and 13. Note that a description of the same points as in the first finding will be omitted as appropriate. FIGS. 12 and 13 are graphs related to the second finding. Specifically, a horizontal axis of a graph RS2 of FIG. 12 represents the unit size of the hidden layer, and a vertical axis represents the accuracy. A graph RS3 of FIG. 13 illustrates a case where a horizontal axis represents the common logarithm (the logarithm with base 10) of the unit size of the hidden layer. The second finding is a finding obtained for a relationship between the unit size and the accuracy of the hidden layer by an experiment (measurement).
The graph RS2 of FIG. 12 and the graph RS3 of FIG. 13 indicate that there is a high correlation between the unit size of the hidden layer and the accuracy. In the graph PS2 of FIG. 12 and the graph RS3 of FIG. 13, for example, the accuracy is improved as the unit size of the hidden layer is increased, and it is indicated that there is a positive correlation between the unit size of the hidden layer and the accuracy.

FIGS. 12 and 13 illustrate results obtained by fixing the unit size of the hidden layer and adjusting the dropout rate. The results show that the accuracy of the model was improved by adjusting the dropout rate while increasing the unit size of the hidden layer.

### [8-3. Third Finding]

First, a third finding will be described with reference to FIG. 14. Note that a description of the same points as in the first and second findings described above will be omitted as appropriate. FIG. 14 is a graph related to the third finding. Specifically, a horizontal axis of a graph RS4 of FIG. 14 represents the unit size of the hidden layer, and a vertical axis indicates the dropout rate.
The graph RS4 of FIG. 14 illustrates a result of extracting and plotting the highest accuracy at each dropout rate. For example, the graph RS4 of FIG. 14 illustrates a result of extracting and plotting the unit size of the hidden layer when the accuracy is highest at each dropout rate. The graph RS4 of FIG. 14 indicates that there is a high correlation between the dropout rate and the unit size of the hidden layer. In the graph RS4 of FIG. 14, it is indicated that there is a positive correlation between the dropout rate and the unit size of the hidden layer like the function FC11 indicated by a dotted line in the graph RS4.
For example, the function FC11 may be a function expressed by “y=ax+b” (a and b are numerical values), in which a variable corresponding to the unit size of the hidden layer is “y” and a variable corresponding to the dropout rate is “x”. For example, the function FC11 is derived by appropriately using various technologies related to fitting of the function. Note that, in the example of FIG. 14, a case where the function is linear has been illustrated as an example. However, as long as the relationship between the dropout rate and the unit size of the hidden layer can be expressed, the function FC1 may be any function. The function FC1l may be a linear function or may be a nonlinear function.

By using the third finding, a parameter search time can be significantly shortened. For example, by using the function FC11 as illustrated in FIG. 14, the information processing apparatus 10 can determine the unit size of the hidden layer appropriate for each dropout rate. As a result, the information processing apparatus 10 can shorten the time for determining the unit size of the hidden layer based on the dropout rate. The information processing apparatus 10 can appropriately generate a model having a size based on the dropout rate. The information processing apparatus 10 generates a model based on the size (target size) of the hidden layer corresponding to the dropout rate specified based on the function FC11. For example, the information processing apparatus 10 inputs the acquired dropout rate to the function FC11 to specify the target size of the hidden layer corresponding to the acquired dropout rate.

Then, the information processing apparatus 10 trains a plurality of models respectively corresponding to a plurality of sizes within a predetermined range from the target size. For example, the information processing apparatus 10 trains a plurality of models respectively corresponding to a plurality of sizes included in a range of ±5% of the target size. The information processing apparatus 10 selects one model with the highest accuracy among the plurality of trained models as an appropriate model corresponding to the dropout rate. As a result, the information processing apparatus 10 generates a model including the hidden layer having a size within a predetermined range from the target size and corresponding to the acquired dropout rate.

### [8-4. Fourth Finding]

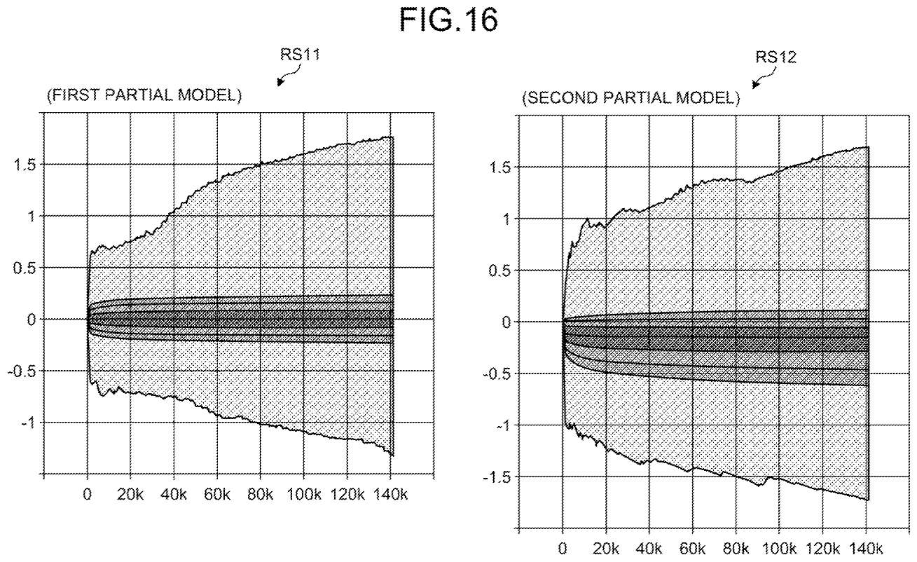

First, a fourth finding will be described with reference to FIGS. 15 and 16. Note that a description of the same points as in the first, second, and third findings described above will be omitted as appropriate. FIG. 15 is a diagram illustrating an example of a model related to the fourth finding. FIG. 16 is a graph related to the fourth finding.

FIG. 15 illustrates a case where the parameters of the partial model PM1 that is the first-type partial model of the model M1 and the partial model PM2 that is the second-type partial model of the model M1 are set. Specifically, FIG. 15 illustrates a case where the dropout rate of the partial model PM1 is set to “0.7021”. FIG. 15 illustrates a case where the dropout rate of the partial model PM1 is set to “0.6257” and the unit size (the number of nodes) of the hidden layer is set to 1519. In addition, in FIG. 15, the embedding layer EL11 and the logits layer EL12 are directly connected as fully connected layers.

Here, a relationship between the weight, which is the parameter of the model, and a step will be described with reference to FIG. 16. A graph RS11 of FIG. 16 illustrates a relationship between the weight for the partial model PM1 that is the first partial model and the step. A horizontal axis of the graph RS11 of FIG. 16 represents the step, and a vertical axis represents the logit (the output of the partial model).

The graph RS11 illustrates a relationship between the output of the first partial model (partial model PM1) and the step. A waveform in the graph RS11 indicates a variation in the output of the model by its standard deviation. Nine waveforms in the graph RS11 correspond to maximum (maximum value), μ+1.5σ, μ+σ, μ+0.5σ, μ, μ−0.5σ, μ−σ, μ−1.5σ, and minimum (minimum value), respectively, in order from the top. The example of FIG. 16 illustrates an aspect in which the center p is the darkest and the color becomes lighter toward the outer side.

A graph RS12 of FIG. 16 illustrates a relationship between the weight for the partial model PM2 that is the second partial model and the step. A horizontal axis of the graph RS12 of FIG. 16 represents the step, and a vertical axis represents the logit (the output of the partial model).

The graph RS12 illustrates a relationship between the output of the second partial model (partial model PM2) and the step. A waveform in the graph RS12 indicates a variation in the output of the model by its standard deviation. Nine waveforms in the graph RS12 correspond to maximum (maximum value), μ+1.5σ, μ+σ, μ+0.5σ, μ, μ−0.5σ, μ−σ, μ−1.5σ, and minimum (minimum value), respectively, in order from the top.

As illustrated in FIG. 16, the variation in weight cart be reduced by increasing the dropout rate. For example, it is possible to significantly reduce the L2 norm of the weight by increasing the dropout rate. For example, in a case where the variation in weight (the L2 norm or the like) of the first partial model can be reduced, the generalization performance of the model can be improved. Note that the norm of the weight is disclosed in, for example, the following literature.

Generalization in Deep Learning, Kenji Kawaguchi et al. <https://arxiv.org/abs/1710.05468>

### [8-5. Fifth Finding]

Next, a fifth finding will be described. Note that a description of the same points as in the first, second, third, and fourth findings described above will be omitted as appropriate. The fifth finding indicates that the accuracy of the model can be improved by connecting a plurality of partial models in parallel as depicted in the model M1 in FIGS. 7 and 15. For example, by connecting a plurality of partial models in parallel, the accuracy of the model can be improved as compared with a case where the partial models are not connected in parallel.

### [8-6. Sixth Finding]

Next, a sixth finding will be described. Note that a description of the same points as in the first to fifth findings described above will be omitted as appropriate. The sixth finding is a supposition that an increase of the dropout rate results in an increase of sparsity and a reduction of the variation in weight (L2 norm or the like).

### [8-7. Experimental Results]

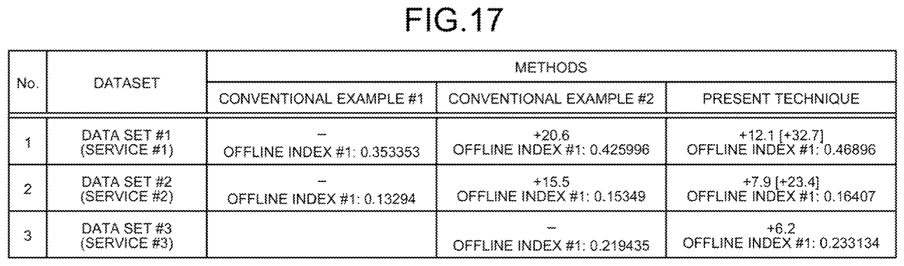

An example of the experimental result will be described with reference to FIG. 17. FIG. 17 is a diagram illustrating a list of experimental results. FIG. 17 illustrates experimental results in a case where data sets #1 to 43 of three services including services 41 to #3 are used. Note that, although the services are represented by abstract names such as the services #1 to #3, for example, the service #1 is an information providing service, the service #2 is a book-selling service, and the service #3 is a travel service.

An “offline index #1” in FIG. 17 indicates an index serving as a reference of the accuracy of the model. The offline index #1 indicates a proportion of a correct answer in candidates extracted in descending order of score output by the model. For example, the offline index #1 indicates a proportion of books (having, for example, a content such as a corresponding page) actually browsed by the user in five target books extracted in descending order of score output by the model as the behavior data of the user is input to the model.

In the list in FIG. 17, “conventional example #1” indicates a first conventional example, and “conventional example #2” indicates a second conventional example in which the accuracy is improved as compared with the first conventional example. Furthermore, in the list in FIG. 17, “present technique” indicates the accuracy of the model in which a plurality of partial models are connected in parallel and which is generated by the above-described processing.

A value positioned next to the “offline index #1:” in each field of the experimental results illustrated in FIG. 17 indicates the accuracy in a case of using the corresponding data set for each technique. For example, “offline index #1: 0.353353” written in a field corresponding to the “conventional example #1” and the “data set #1” indicates that the accuracy of the conventional example #1 was 0.353353 in a case where the data set #1 of the service #1 is set as a target. Further, a blank field corresponding to the “conventional example #1” and the “data set #3” indicates that the accuracy of the conventional example #1 in a case where the data set #3 of the service #3 is set as the target was not acquired (not measured).

A numerical value shown in a field corresponding to the “conventional example #2” indicates an accuracy improvement rate with respect to the “conventional example #1”. For example, “+20.6” written in a field corresponding to the “conventional example #2” and the “data set #1” indicates that, in a case where the data set #1 of the service #1 is set as the target, the accuracy in the conventional example #2 was improved by 20.6% as compared with the conventional example #1.

In addition, a numerical value shown in a field corresponding to the “present technique” indicates an accuracy improvement rate with respect to the “conventional example #2”, and a numerical value enclosed in parentheses next thereto indicates an accuracy improvement rate with respect to the “conventional example #1”. For example, “+12.1” written in a field corresponding to the “present technique” and the “data set #1” indicates that, in a case where the data set #1 of the service #1 is set as the target, the accuracy in the present technique was improved by 12.1% as compared with the conventional example #2. Furthermore, for example, “[+32.7]” next to “+12.1” written in the field corresponding to the “present technique” and the “data set #1” indicates that, in a case where the data set #1 of the service #1 is set as the target, the accuracy in the present technique was improved by 32.7% as compared with the conventional example #1.

Similarly, in a case where the data set 12 of the service #2 is set as the target, the accuracy in the present technique was improved by 7.9% as compared with the conventional example #2, and the accuracy in the present technique was improved by 23.4% as compared with the conventional example #1. In addition, in a case where the data set #3 of the service #3 is set as the target, the accuracy in the present technique was improved by 6.2% as compared with the conventional example #2. As illustrated in rig. 17, the accuracy in the present technique was improved (increased) as compared with the conventional example #1 and the conventional example #2.

### [9. Modification]

An example of the information processing has been described hereinabove. However, the embodiment is not limited thereto. Hereinafter, a modification of the information processing will be described.

### [9-1. Configuration of Apparatus]

In the above-described embodiment, an example, in which the information processing system 1 includes the information processing apparatus 10 that generates the generation index and the model generation server 2 that generates the model according to the generation index has been described, but the embodiment is not limited thereto. For example, the information processing apparatus 10 may have the function of the model generation server 2. Furthermore, the terminal apparatus 3 may have the function of the information processing apparatus 10. In such a case, the terminal apparatus 3 automatically generates the generation index and automatically generates the model using the model generation server 2.

### [9-2. Others]

In addition, all or some types of processing described as being automatically performed among the types of processing described in the above embodiment can be manually performed or all or some types of processing described as being manually performed among the types of processing described in the above embodiment can be automatically performed by a known method. In addition, processing procedures, specific names, and information including various pieces of data or parameters illustrated in the above document or the drawings can be arbitrarily changed unless otherwise specified. For example, various pieces of information illustrated in each drawing are not limited to the illustrated pieces of information.

In addition, each component of the respective apparatuses that are illustrated is a functional concept, and does not necessarily have to be physically configured as illustrated. That is, specific forms of distribution and integration of the respective apparatuses are not limited to those illustrated, and all or some of the respective apparatuses can be configured to be functionally or physically distributed and integrated in any units according to various loads, use situations, or the like.

In addition, the respective embodiments described above can be appropriately combined with each other as long as processing contents do not contradict each other.

### [9-3. Program]

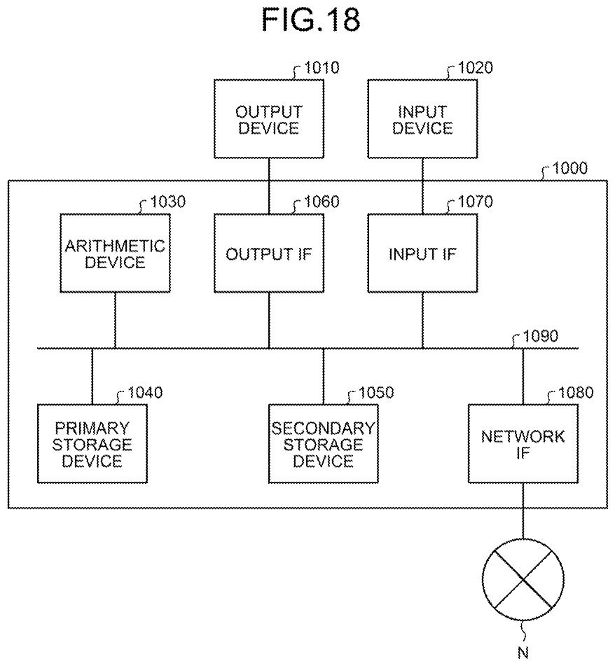

In addition, the information processing apparatus 10 according to the embodiment described above is implemented by, for example, a computer 1000 having a configuration as illustrated in FIG. 18. FIG. 18 is a diagram illustrating an example of a hardware configuration. The computer 1000 is connected to an output device 1010 and an input device 1020, and has a form in which an arithmetic device 1030, a primary storage device 1040, a secondary storage device 1050, an output interface (IF) 1060, an input IF 1070, and a network IF 1080 are connected to each other by a bus 1090.

The arithmetic device 1030 operates based on a program stored in the primary storage device 1040 or the secondary storage device 1050, a program read from the input device 1020, or the like, and performs various types of processing. The primary storage device 1040 is a memory device that primarily stores data used by the arithmetic device 1030 for various arithmetic operations, such as a RAM. In addition, the secondary storage device 1050 is a storage device in which data used by the arithmetic device 1030 for various arithmetic operations or various databases are registered, and is implemented by, a read only memory (ROM), an HDD, a flash memory, or the like.

The output. IF 1060 is an interface for transmitting target information to be output to the output device 1010 that outputs various pieces of information, such as a monitor and a printer, and is implemented by, for example, a connector of a standard such as a universal serial bus (USB), a digital visual interface (DVI), and a high definition multimedia interface (HDMI) (registered trademark). In addition, the input IF 1070 is an interface for receiving information from various input devices 1020 such as a mouse, a keyboard, and a scanner, and is implemented by, for example, a USB.

Note that the input device 1020 may be, for example, a device that reads information from an optical recording medium such as a compact disc (CD), a digital versatile disc (DVD), or a phase change rewritable disk (PD), a magneto-optical recording medium such as a magneto-optical disk (MO), a tape medium, a magnetic recording medium, a semiconductor memory, or the like. In addition, the input device 1020 may be an external storage medium such as a USB memory.

The network IF 1080 receives data from another apparatus via the network N and sends the received data to the arithmetic device 1030, and also transmits data generated by the arithmetic device 1030 to another apparatus via the network N.

The arithmetic device 1030 controls the output device 1010 or the input device 1020 via the output IF 1060 or the input IF 1070. For example, the arithmetic device 1030 loads a program from the input device 1020 or the secondary storage device 1050 onto the primary storage device 1040, and executes the loaded program.

For example, in a case where the computer 1000 functions as the information processing apparatus 10, the arithmetic device 1030 of the computer 1000 implements a function of the control unit 40 by executing the program loaded onto the primary storage device 1040.

### [10. Effect]

As described above, the information processing apparatus 10 includes: the acquisition unit (in the embodiment, the acquisition unit 41) that acquires learning data used for training of a model (for example, the model M1 in the embodiment) including the first partial model (for example, the partial model PM1 in the embodiment) and the second partial model (for example, the partial model PM2 in the embodiment); and the generation unit (in the embodiment, the generation unit 44) that generates, by using the learning data, the model in a manner in which the first partial model is trained by the first dropout based on the first dropout rate and the second partial model is trained by the second dropout based on the second dropout rate different from the first dropout rate. As a result, the information processing apparatus 10 can appropriately generate a model by training according to the structure of the model. In addition, the experimental results in a case of using the model generated by the dropout in which the dropout rate is set for each partial model show that the accuracy of the model is improved. Therefore, the information processing apparatus 10 can improve the accuracy of the model by training the model by the dropout in which the dropout rate is set for each partial model.

In addition, the second partial model includes a larger number of layers than the first partial model. As described above, the information processing apparatus 10 can generate a model including a plurality of partial models including different numbers of layers, and can appropriately generate a model by training according to the structure of the model.

The second partial model includes the hidden layer. As a result, the information processing apparatus 10 can generate a model including a partial model including the hidden layer, and can appropriately generate a model by training according to the structure of the model.

In addition, the model includes the input layer to which the learning data is input, and an output from the input layer is input to each of the first partial model and the second partial model. As a result, the information processing apparatus 10 can generate a model which includes the input layer to which the learning data is input and in which an output of the input layer is input to each partial model, and can appropriately generate a model by training according to the structure of the model.

In addition, the first partial model includes the first embedding layer in which an input from the input layer is embedded, and the second partial model includes the second embedding layer in which an input from the input layer is embedded. As a result, the information processing apparatus 10 can generate a model including a plurality of partial models each including the embedding layer, and can appropriately generate a model by training according to the structure of the model.

The model also includes the combining layer that combines an output from the first partial model and an output from the second partial model. As a result, the information processing apparatus 10 can generate a model including the combining layer that combines the output from the first partial model and the output from the second partial model, and can appropriately generate a model by training according to the structure of the model.

In addition, the first partial model includes the first output layer whose output is input to the combining layer, and the second partial model includes the second output layer whose output is input to the combining layer. As a result, the information processing apparatus 10 can generate a model including a plurality of partial models each including the output layer whose output is input to the combining layer, and can appropriately generate a model by training according to the structure of the model.

In addition, the combining layer includes the softmax layer. As a result, the information processing apparatus 10 can generate a model including the combining layer which includes the softmax layer and to which the learning data is input, and can appropriately generate a model by training according to the structure of the model.

In addition, the combining layer performs the combining processing for the output of the first partial model and the output of the second partial model before the softmax layer. As a result, the information processing apparatus 10 can generate a model including the combining layer that performs the combining processing for the output of the first partial model and the output of the second partial model before the softmax layer, and can appropriately generate a model by learning according to the structure of the model.

Further, the generation unit generates the model by performing the batch normalization after the first dropout for training. As a result, the information processing apparatus 10 can appropriately combine and process the dropout and the batch normalization, and thus can appropriately generate a model by training according to the structure of the model.

In addition, the generation unit generates the model by performing the batch normalization after the second dropout for training. As a result, the information processing apparatus 10 can appropriately combine and process the dropout and the batch normalization, and thus can appropriately generate a model by training according to the structure of the model.

Further, the acquisition unit acquires information indicating the first dropout rate. The generation unit generates the model including the first partial model having a size based on the first dropout rate. As a result, the information processing apparatus 10 can generate a model including a partial model having a size according to the dropout rate, and thus can appropriately generate a model by training according to the structure of the model.

Further, the acquisition unit acquires information indicating the second dropout rate. The generation unit generates the model including the second partial model having a size based on the second dropout rate. As a result, the information processing apparatus 10 can generate a model including a partial model having a size according to the dropout rate, and thus can appropriately generate a model by training according to the structure of the model.

Further, the generation unit generates the model including the second partial model that includes the hidden layer based on the second dropout rate. As a result, the information processing apparatus 10 can generate a model including a partial model including the hidden layer based on the dropout rate, and thus can appropriately generate a model by training according to the structure of the model.

Further, the generation unit generates the model including the second partial model that includes the hidden layer having a size determined based on the second dropout rate. As a result, the information processing apparatus 10 can generate a model including a partial model including the hidden layer having a size deter-mined based on the dropout rate, and thus can appropriately generate a model by training according to the structure of the model.

Further, the generation unit requests the model generation server to train a model by transmitting data used for model generation to the external model generation server (the “model generation server 2” in the embodiment), and receives the model trained by the model generation server from the model generation server, thereby generating the model. As a result, the information processing apparatus 10 can cause the model generation server to train a model and receive the model, thereby appropriately generating the model. For example, the information processing apparatus 10 transmits the learning data, information indicating the structure of the model, information indicating the dropout rate of each partial model, and the like to an external apparatus such as the model generation server 2 that generates a model, and causes the external apparatus to train the model by using the learning data, thereby appropriately generating the model.

Although some of the embodiments of the present application have been described in detail with reference to the drawings hereinabove, these are examples, and it is possible to carry out the present invention in other embodiments in which various modifications and improvements have been made based on knowledge of those skilled in the art, including aspects described in a section of the disclosure of the present invention.

In addition, the “section”, the “module”, and the “unit” described above can be replaced with a “means”, a “circuit”, or the like. For example, the acquisition unit can be replaced with an acquisition means or an acquisition circuit.

### EXPLANATIONS OF LETTERS OR NUMERALS

1 INFORMATION PROCESSING SYSTEM
2 MODEL GENERATION SERVER
3 TERMINAL APPARATUS
10 INFORMATION PROCESSING APPARATUS
20 COMMUNICATION UNIT
30 STORAGE UNIT
40 CONTROL UNIT
41 ACQUISITION UNIT
42 DETERMINATION UNIT
43 RECEPTION UNIT
44 GENERATION UNIT
45 PROVISION UNIT

1. An information processing method executed by a computer, the information processing method comprising:
acquiring learning data used for training of a model including a first partial model and a second partial model; and
generating, by using the learning data, the model in a manner in which the first partial model is trained by first dropout based on a first dropout rate and the second partial model is trained by second dropout based on a second dropout rate different from the first dropout rate.

2. The information processing method according to claim 1, wherein
the second partial model includes a larger number of layers than the first partial model.

3. The information processing method according to claim 1, wherein
the second partial model includes a hidden layer.

4. The information processing method according to claim 1, wherein
the model includes an input layer to which the learning data is input, and an output from the input layer is input to each of the first partial model and the second partial model.

5. The information processing method according to claim 4, wherein
the first partial model includes a first embedding layer in which an input from the input layer is embedded, and
the second partial model includes a second embedding layer in which an input from the input layer is embedded.

6. The information processing method according to claim 1, wherein
the model includes a combining layer that combines an output from the first partial model and an output from the second partial model.

7. The information processing method according to claim 6, wherein
the first partial model includes a first output layer whose output is input to the combining layer, and
the second partial model includes a second output layer whose output is input to the combining layer.

8. The information processing method according to claim 6, wherein
the combining layer includes a softmax layer.

9. The information processing method according to claim 8, wherein
the combining layer performs combining processing for the output of the first partial model and the output of the second partial model before the softmax layer.

10. The information processing method according to claim 1, further comprising
generating the model by performing batch normalization after the first dropout for training.

11. The information processing method according to claim 1, further comprising
generating the model by performing batch normalization after the second dropout for training.

12. The information processing method according to claim 1, further comprising
acquiring information indicating the first dropout rate, and
generating the model including the first partial model having a size based on the first dropout rate.

13. The information processing method according to claim 1, further comprising
acquiring information indicating the second dropout rate, and
generating the model including the second partial model having a size based on the second dropout rate.

14. The information processing method according to claim 13, further comprising
generating the model including the second partial model including a hidden layer based on the second dropout rate.

15. The information processing method according to claim 14, further comprising
generating the model including the second partial model including a hidden layer having a size determined based on the second dropout rate.

16. An information processing apparatus comprising:
an acquisition unit that acquires learning data used for training of a model including a first partial model and a second partial model; and
a generation unit that generates, by using the learning data, the model in a manner in which the first partial model is trained by first dropout based on a first dropout rate and the second partial model is trained by second dropout based on a second dropout rate different from the first dropout rate.

17. A non-transitory computer-readable storage medium having stored therein an information processing program for causing a computer to execute:
acquiring learning data used for training of a model including a first partial model and a second partial model; and
generating, by using the learning data, the model in a manner in which the first partial model is trained by first dropout based on a first dropout rate and the second partial model is trained by second dropout based on a second dropout rate different from the first dropout rate.

18. A non-transitory computer-readable storage medium having stored therein an information processing program for causing a computer to be operated as a model including a first partial model and a second partial model,
the model being trained by using learning data in a manner in which the first partial model is trained by dropout based on a first dropout rate and the second partial model is trained by dropout based on a second dropout rate different from the first dropout rate.
